(19) United States
(12) Patent Application Publication
(10) Pub. No.: US 2025/0287397 A1
(43) Pub. Date: Sep. 11, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/859,789

(22) PCT Filed: Apr. 28, 2022
(86) PCT No.: PCT/JP2022/019404

§ 371 Date: Oct. 24, 2024

(51) Int. Cl. H04W 72/232; H04W 72/1268

(52) U.S. Cl. CPC H04W 72/232; H04W 72/1268

(57) ABSTRACT

A terminal according to one aspect of the present disclosure includes a receiving section that receives one downlink control information used for scheduling of transmission of one or more uplink shared channels using a first frequency resource and a second frequency resource, the first resource corresponding to a first beam or panel, and the second frequency resource corresponding to a second beam or panel and being frequency-division multiplexed with the first frequency domain resource, and a control section that determines the first frequency resource and the second frequency resource, based on the downlink control information.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, Rel-17/18 (or later versions) NR), it is assumed that a UE performs UL transmission by using a plurality of beams (or panels). In this case, it is also assumed that UL transmissions (or UL transmission resources) corresponding to the respective beams/panels are allocated (for example, frequency-division multiplexed (FDMed)) not to overlap each other in a frequency direction so as to be controlled.

However, a study has not been sufficiently made on how to control UL transmission in such a case. Unless the UL transmission using the plurality of beams/panels is appropriately performed, degradation in system performance, such as throughput reduction, may occur.

Thus, an object of the present disclosure is to provide a terminal, a radio communication method, and a base station that appropriately perform simultaneous UL transmission using a plurality of beams/panels.

### Solution to Problem

A terminal according to one aspect of the present disclosure includes a receiving section that receives one downlink control information used for scheduling of transmission of one or more uplink shared channels using a first frequency resource corresponding to a first beam or panel, and a second frequency resource corresponding to a second beam or panel and frequency-division multiplexed with the first frequency domain resource, and a control section that determines the first frequency resource and the second frequency resource, based on the downlink control information.

### Advantageous Effects of Invention

According to one aspect of the present disclosure, it is possible to appropriately perform simultaneous UL transmission using a plurality of beams/panels.

### BRIEF DESCRIPTION OF DRAWINGS

FIG. 1 is a diagram to illustrate an example of association between precoder types and TPMI indices.

FIGS. 2A and 2B are diagrams to illustrate examples of single-panel UL transmission.

FIGS. 3A to 3C are diagrams to illustrate examples of simultaneous UL transmission schemes 1 to 3 using multi-panel.

FIG. 4 is a diagram to illustrate an example of PUSCH repetition transmission to which SDM is applied.

FIG. 5A is a diagram to illustrate a first example of PUSCH repetition transmission to which FDM is applied. FIG. 5B is a diagram to illustrate a second example of the PUSCH repetition transmission to which the FDM is applied.

FIGS. 6A and 6B are diagrams to illustrate examples of an FDM scheme.

FIG. 7 is a diagram to illustrate an example of a table for an RV to be applied to PUSCH repetition (TDM).

FIGS. 8A to 8C are diagrams to illustrate examples of FDM Schemes #1 to #3.

FIG. 9 is a diagram to illustrate an example of frequency domain resource allocation for a PUSCH according to a first embodiment.

FIGS. 10A and 10B are diagrams to illustrate other examples of the frequency domain resource allocation for the PUSCH according to the first embodiment.

FIG. 11 is a diagram to illustrate another example of the frequency domain resource allocation for the PUSCH according to the first embodiment.

FIGS. 12A and 12B are diagrams to illustrate examples of TB size determination according to a second embodiment.

FIGS. 13A and 13B are diagrams to illustrate other examples of the TB size determination according to the second embodiment.

FIGS. 14A and 14B are diagrams to illustrate examples of frequency density of a PTRS according to a third embodiment.

FIGS. 15A and 15B are diagrams to illustrate other examples of the frequency density of the PTRS according to the third embodiment.

FIG. 16 is a diagram to illustrate another example of the frequency density of the PTRS according to the third embodiment.

FIG. 17 is a diagram to illustrate an example of a table used for RV determination in an FDM scheme according to a fourth embodiment.

FIG. 18 is a diagram to illustrate an example of PUSCH repetition using TDM.

FIG. 19 is a diagram to illustrate an example of a schematic structure of a radio communication system according to one embodiment.

FIG. 20 is a diagram to illustrate an example of a structure of a base station according to one embodiment.

FIG. 21 is a diagram to illustrate an example of a structure of a user terminal according to one embodiment.

FIG. 22 is a diagram to illustrate an example of a hardware structure of the base station and the user terminal according to one embodiment.

FIG. 23 is a diagram to illustrate an example of a vehicle according to one embodiment.

### DESCRIPTION OF EMBODIMENTS

### Repetition Transmission

In Rel. 15, repetition transmission is supported in data transmission. For example, a base station (a network (NW), a gNB) may repeat transmission of DL data (for example, a downlink shared channel (PDSCH)) given times. Alternatively, a UE may repeat UL data (for example, an uplink shared channel (PUSCH)) given times.

A given number of PUSCH repetition transmissions may be scheduled for the UE by a single DCI. The number of repetitions is also referred to as a repetition factor K or an aggregation factor K.

The n th repetition is also referred to as the n th transmission occasion or the like, and may be identified by a repetition index k (0≤k≤K−1). The repetition transmission may be applied to a PUSCH dynamically scheduled by the DCI (for example, a dynamic grant-based PUSCH), or may be applied to a configured grant-based PUSCH.

The UE semi-statically receives information indicating the repetition factor K (for example, aggregationFactorUL or aggregationFactorDL) by using higher layer signaling. Here, for example, the higher layer signaling may be any one or combinations of RRC (Radio Resource Control) signaling, MAC (Medium Access Control) signaling, broadcast information, and the like.

For example, the MAC signaling may use MAC control elements (MAC CE), MAC PDUs (Protocol Data Units), and the like. For example, the broadcast information may be master information blocks (MIBs), system information blocks (SIBs), minimum system information (RMSI (Remaining Minimum System Information)), and the like.

The UE controls PDSCH reception processing (for example, at least one of reception, demapping, demodulation, and decoding) or PUSCH transmission processing (for example, at least one of transmission, mapping, modulation, and coding) in K consecutive slots, based on a field value of at least one of the following (or information indicated by the field value) in the DCI:
Allocation of time domain resources (for example, start symbols, the number of symbols in each slot, or the like)
Allocation of frequency domain resources (for example, a given number of resource blocks (RBs) or a given number of resource block groups (RBGs))
Modulation and coding scheme (MCS) index
Configuration of PUSCH demodulation reference signal (DMRS)
PUSCH spatial relation information (spatial relation info) or transmission configuration indication (TCI (Transmission Configuration Indication or Transmission Configuration Indicator)) state (TCI state (TCI-state))

Identical symbol allocation may be applied to the K consecutive slots. The UE may determine symbol allocation in each slot, based on a start symbol S and the number L of symbols (for example, a Start and Length Indicator (SLIV)) determined based on a value m of a given field (for example, a time domain resource allocation (TDRA) field) in DCI. Note that the UE may determine the first slot, based on K2 information determined based on the value m of the given field (for example, the TDRA field) of the DCI.

On the other hand, in the K consecutive slots, redundancy versions (RVs) each applied to a TB based on identical data may be identical to each other or may be at least partially different from each other. For example, the RV applied to the TB in the n th slot (transmission occasion, repetition) may be determined based on a value of a given field (for example, an RV field) in DCI.

In Rel. 15, PUSCH repetition transmission can be performed over a plurality of slots (in units of a slot). Rel. 16 (or later versions) supports PUSCH repetition transmission in units of anything shorter than the slot (for example, units of a sub-slot, units of a mini-slot, or units of a given number of symbols).

The UE may determine symbol allocation for PUSCH transmission (for example, a PUSCH with k=0) in a given slot, based on a start symbol S and the number L of symbols determined based on a value m of a given field (for example, a TDRA field) in DCI for the PUSCH. Note that the UE may determine the given slot, based on Ks information determined based on the value m of the given field (for example, the TDRA field) of the DCI.

The UE may dynamically receive information indicating a repetition factor K (for example, numberofrepetitions) by using downlink control information. The repetition factor may be determined based on the value m of the given field (for example, the TDRA field) in the DCI. For example, a table in which correspondence between a bit value, the repetition factor K, the start symbol S, and the number L of symbols notified by the DCI is defined may be supported.

The slot-based repetition transmission may be referred to as a repetition transmission type A (for example, PUSCH repetition Type A), and the sub-slot-based repetition transmission may be referred to as a repetition transmission type B (for example, PUSCH repetition Type B).

The UE may be configured with application of at least one of the repetition transmission type A and the repetition transmission type B. For example, the UE may be notified of a repetition transmission type to be applied by the UE, from the base station, by using higher layer signaling (for example, PUSCHRepTypeIndicator).

The UE may be configured with any one of the repetition transmission type A and the repetition transmission type B for each DCI format for scheduling the PUSCH.

For example, for a first DCI format (for example, DCI format 0_1), when higher layer signaling (for example, PUSCHRepTypeIndicator-AorDCIFormat0_1) is configured for the repetition transmission type B (for example, PUSCH-RepTypeB), the UE applies the repetition transmission type B to PUSCH repetition transmission scheduled by the first DCI format. In a case other than that (for example, a case where PUSCH-RepTypeB is not configured or a case where PUSCH-RepTypeA is configured), the UE applies the repetition transmission type A to PUSCH repetition transmission scheduled by the first DCI format.

### PUSCH Precoder

For NR, it is studied that the UE supports at least one of codebook (CB) based transmission and non-codebook (NCB) based transmission.

For example, it is studied that the UE determines a precoder (precoding matrix) for at least one of CB based and NCB based uplink shared channel (Physical Uplink Shared Channel (PUSCH)) transmissions by using at least a sounding reference signal (SRS) resource indicator (SRS Resource Indicator (SRI)).

In a case of the CB based transmission, the UE may determine a precoder for the PUSCH transmission, based on an SRI, a transmitted rank indicator (TRI), a transmitted precoding matrix indicator (TPMI), and the like. In a case of the NCB based transmission, the UE may determine a precoder for the PUSCH transmission, based on the SRI.

The UE may be notified of the SRI, the TRI, the TPMI, and the like by using downlink control information (DCI). The SRI may be specified by an SRS Resource Indicator field (SRI field) of the DCI or may be specified by a parameter “srs-ResourceIndicator” included in an RRC information element “ConfiguredGrantConfig” for a configured grant PUSCH. The TRI and the TPMI may be specified by precoding information and number of layers field (“Precoding information and number of layers” field) of the DCI.

The UE may report UE capability information related to a precoder type and be configured, by a base station, with the precoder type based on the UE capability information by higher layer signaling. The UE capability information may be precoder type information to be used by the UE in PUSCH transmission (which may be indicated by an RRC parameter “pusch-TransCoherence”).

The UE may determine a precoder to be used for the PUSCH transmission, based on precoder type information (which may be indicated by an RRC parameter “codebookSubset”) included in PUSCH configuration information notified by higher layer signaling (“PUSCH-Config” information element of RRC signaling). The UE may be configured with a subset of PMIs specified by the TPMI, by codebookSubset.

Note that the precoder type may be specified by any of or a combination of at least two of full coherent (fully coherent, coherent), partial coherent, and non-coherent (non coherent) (which may be indicated, for example, by a parameter such as “fullyAndPartialAndNonCoherent” or “partialAndNonCoherent.”

Full coherent may mean that all the antenna ports to be used for transmission are synchronized (which may be expressed as being able to be matched in terms of phase, being able to phase-control for each coherent antenna port, being able to appropriately apply a precoder for each coherent antenna port, and the like). Partial coherent may mean that some ports of the antenna ports to be used for transmission are synchronized but the ports and the other ports are not synchronized. Non-coherent may mean that the antenna ports to be used for transmission are not synchronized.

Note that a UE that supports the precoder type, full coherent, may be assumed to support the precoder types, partial coherent and non-coherent. A UE that supports the precoder type, partial coherent, may be assumed to support the precoder type, non-coherent.

The precoder type may be interpreted as coherency, PUSCH transmission coherence, a coherent type, a coherence type, a codebook type, a codebook subset, a codebook subset type, and the like.

The UE may determine a precoding matrix corresponding to the TPMI index obtained from DCI for scheduling UL transmission (for example, DCI format 0_1, this similarly applies below), from a plurality of precoders (which may be referred to as a precoding matrix, a codebook, and the like) for CB based transmission.

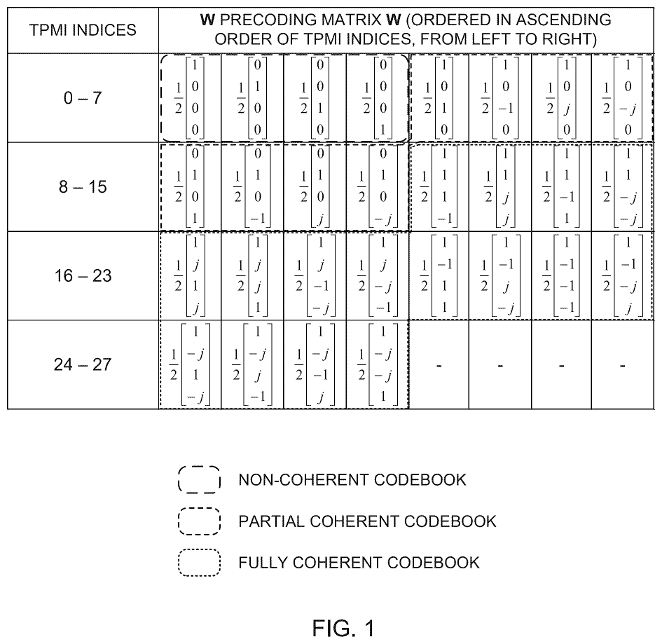

FIG. 1 is a diagram to illustrate an example of association between precoder types and TPMI indices. FIG. 1 corresponds to a table for a precoding matrix W for single layer (rank 1) transmission using 4 antenna ports in DFT-s-OFDM (Discrete Fourier Transform spread OFDM, transform precoding is enabled).

In FIG. 1, when a precoder type (codebookSubset) is fully AndPartialAndNonCoherent, the UE is notified of a TPMI of any of 0 to 27 for the single layer transmission. When the precoder type is partialAndNonCoherent, the UE is configured with a TPMI of any of 0 to 11 for the single layer transmission. When the precoder type is nonCoherent, the UE is configured with a TPMI of any of 0 to 3 for the single layer transmission.

Note that, as illustrated in FIG. 1, precoding matrices each having only one non-zero element of each column may be referred to as a non-coherent codebook. Precoding matrices each having a given number of non-zero elements of each column (except for all the elements) may be referred to as a partial coherent codebook. Precoding matrices each having all the elements of each column being non-zero may be referred to as a fully coherent codebook.

The non-coherent codebook and the partial coherent codebook may be referred to as an antenna selection precoder. The fully coherent codebook may be referred to as a non-antenna selection precoder.

Note that, in the present disclosure, the partial coherent codebook may correspond to the codebook obtained by removing a codebook corresponding to a TPMI specified for the UE configured with a non-coherent codebook subset (for example, an RRC parameter “codebookSubset”=“nonCoherent”), from codebooks (precoding matrices) corresponding to TPMIs specified by DCI for codebook based transmission for the UE configured with a partial coherent codebook subset (for example, an RRC parameter “codebookSubset”=“partialAndNonCoherent”) (in other words, a codebook with TPMIs=4 to 11 in a case of single layer transmission with 4 antenna ports).

Note that, in the present disclosure, the fully coherent codebook may correspond to the codebook obtained by removing a codebook corresponding to a TPMI specified for the UE configured with a partial coherent codebook subset (for example, an RRC parameter “codebookSubset”=“partialAndNonCoherent”), from codebooks (precoding matrices) corresponding to TPMIs specified by DCI for codebook based transmission for the UE configured with a fully coherent codebook subset (for example, an RRC parameter “codebookSubset”=“fullyAndPartialAndNonCoherent”) (in other words, a codebook with TPMIs=12 to 27 in a case of single layer transmission with 4 antenna ports).

### Spatial Relations for SRS and PUSCH

The UE may receive information to be used for transmission of a reference signal for measurement (for example, sounding reference signal (SRS)) (SRS configuration information, for example, a parameter in an RRC control element “SRS-Config”).

Specifically, the UE may receive at least one of information related to one or a plurality of SRS resource sets (SRS resource set information, for example, an RRC control element “SRS-ResourceSet”) and information related to one or a plurality of SRS resources (SRS resource information, for example an RRC control element “SRS-Resource”).

One SRS resource set may be related to a given number of SRS resources (may group the given number of SRS resources). Each SRS resource may be identified by an SRS resource indicator (SRI) or an SRS resource ID (Identifier).

The SRS resource set information may include an SRS resource set ID (SRS-ResourceSetId), a list of SRS resource IDs (SRS-ResourceId) used in the resource set, an SRS resource type, and information of SRS usage.

Here, the SRS resource type may indicate any one of a periodic SRS (P-SRS), a semi-persistent SRS (SP-SRS), and an aperiodic SRS (A-SRS, AP-SRS). Note that the UE may periodically (or, after activation, periodically) transmit the P-SRS and the SP-SRS and may transmit the A-SRS, based on an SRS request of DCI.

The usage (RRC parameter “usage,” L1 (Layer-1) parameter “SRS-SetUse”) may be, for example, beam management (beamManagement), codebook based transmission (codebook (CB)), non-codebook based transmission (nonCodebook (NCB)), antenna switching, or the like. An SRS with codebook based transmission or non-codebook based transmission usage may be used to determine a precoder for codebook based or non-codebook based PUSCH transmission based on an SRI.

For example, in a case of codebook based transmission, the UE may determine a precoder for the PUSCH transmission, based on an SRI, a transmitted rank indicator (TRI), and a transmitted precoding matrix indicator (TPMI). In a case of non-codebook based transmission, the UE may determine a precoder for the PUSCH transmission, based on the SRI.

The SRS resource information may include an SRS resource ID (SRS-ResourceId), the number of SRS ports, an SRS port number, a transmission Comb, SRS resource mapping (for example, a time and/or frequency resource location, resource offset, a resource periodicity, the number of repetitions, the number of SRS symbols, an SRS bandwidth, or the like), hopping-related information, an SRS resource type, a sequence ID, SRS spatial relation information, and the like.

The SRS spatial relation information (for example, an RRC information element “spatialRelationInfo”) may indicate information about a spatial relation between a given reference signal and an SRS. The given reference signal may be at least one of a synchronization signal/broadcast channel (Synchronization Signal/Physical Broadcast Channel (SS/PBCH)) block, a channel state information reference signal (CSI-RS), and an SRS (for example, another SRS). The SS/PBCH block may be referred to as a synchronization signal block (SSB).

The SRS spatial relation information may include, as an index of the above given reference signal, at least one of an SSB index, a CSI-RS resource ID, and an SRS resource ID.

Note that, in the present disclosure, an SSB index, an SSB resource ID, and an SSBRI (SSB Resource Indicator) may be interchangeably interpreted. A CSI-RS index, a CSI-RS resource ID, and a CRI (CSI-RS Resource Indicator) may be interchangeably interpreted. An SRS index, an SRS resource ID, and an SRI may be interchangeably interpreted.

The SRS spatial relation information may include a serving cell index, a BWP index (BWP ID), and the like corresponding to the above given reference signal.

In NR, uplink signal transmission may be controlled based on the presence or absence of beam correspondence (BC). The BC may be, for example, a capability of a given node (for example, the base station or the UE) to determine a beam (transmit beam or Tx beam) used for signal transmission, based on a beam (receive beam or Rx beam) used for signal reception.

Note that the BC may be referred to as transmit/receive beam correspondence (Tx/Rx beam correspondence), beam reciprocity, beam calibration, calibrated/non-calibrated, reciprocity calibrated/non-calibrated, a level of correspondence, a level of coincidence, and so on.

For example, when the BC is absent, the UE may transmit an uplink signal (for example, a PUSCH, a PUCCH, an SRS, or the like) by using a beam (spatial domain transmission filter) identical to that of an SRS (or SRS resource) indicated from the base station, based on a measurement result of one or more SRSs (or SRS resources).

On the other hand, when the BC is present, the UE may transmit an uplink signal (for example, a PUSCH, a PUCCH, an SRS, or the like) by using a beam (spatial domain transmission filter) identical to or corresponding to a beam (spatial domain reception filter) used for reception of a SSB or CSI-RS (or CSI-RS resource).

Regarding a SRS resource, when spatial relation information related to an SSB or CSI-RS and an SRS is configured (for example, when the BC is present), the UE may transmit the SRS resource by using the same spatial domain filter (spatial domain transmission filter) as a spatial domain filter (spatial domain reception filter) for reception of the SSB or CSI-RS. In this case, the UE may assume that a UE receive beam of the SSB or CSI-RS and a UE transmit beam of the SRS are the same.

Regarding a SRS (target SRS) resource, when spatial relation information related to another SRS (reference SRS) and the SRS (target SRS) is configured (for example, when the BC is absent), the UE may transmit the target SRS resource by using the same spatial domain filter (spatial domain transmission filter) as a spatial domain filter (spatial domain transmission filter) for transmission of the reference SRS. In other words, in this case, the UE may assume that a UE transmit beam of the reference SRS and a UE transmit beam of the target SRS are the same.

The UE may determine, based on a value of a given field (for example, an SRS resource indicator (SRI) field) in DCI (for example, DCI format 0_1), a spatial relation for a PUSCH scheduled by the DCI. Specifically, the UE may use, for PUSCH transmission, spatial relation information (for example, an RRC information element “spatialRelationInfo”) of an SRS resource determined based on the value of the given field (for example, the SRI).

When codebook based transmission is used for the PUSCH, the UE may be configured with two SRS resources by RRC, and one of the two SRS resources may be indicated for the UE by DCI (1-bit given field). When non-codebook based transmission is used for the PUSCH, the UE may be configured with four SRS resources by the RRC, and one of the four SRS resources may be indicated for the UE by the DCI (2-bit given field). RRC reconfiguration is necessary for use of a spatial relation other than the two or four spatial relations configured by the RRC.

Note that a DL-RS is configurable for spatial relations for the SRS resources used for the PUSCH. For example, for an SP-SRS, the UE is configured with spatial relations for a plurality of (for example, up to 16) SRS resources by RRC, and one of the plurality of SRS resources can be indicated for the UE by a MAC CE.

### Single-Panel Transmission

At least one of Transmission Schemes A and B below (single-panel UL transmission schemes A and B) may be applied to a single-panel UL transmission scheme or candidates for the single-panel UL transmission scheme. Note that, in the present disclosure, a panel/UE panel may be interpreted as a UE capability value set reported for each UE capability.

### Transmission Scheme A: Single-Panel Single-TRP UL Transmission

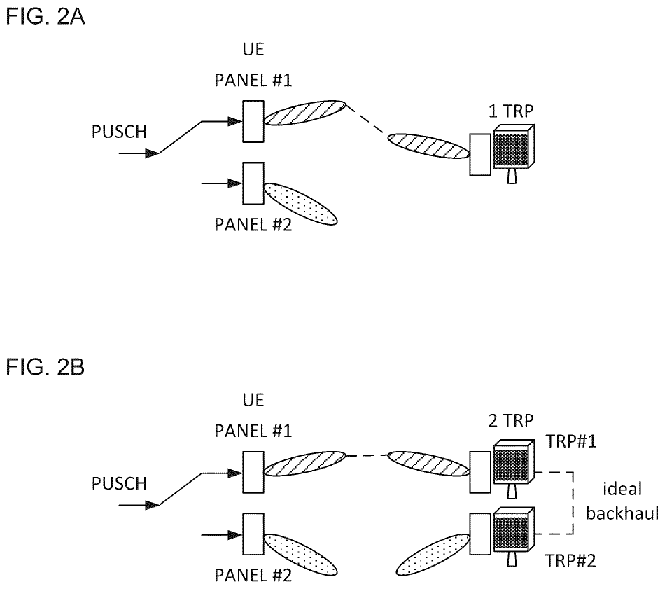

The UE in Rel. 15 and Rel. 16 uses a transmission scheme in which UL is transmitted to one TRP from only one beam and panel at one timing (FIG. 2A).

### Transmission Scheme B: Single-Panel Multi-TRP UL Transmission

In Rel. 17, it is studied that UL transmission from only one beam and panel is performed at one timing to perform repetition transmission to a plurality of TRPs (FIG. 2B). In an example in FIG. 2B, the UE transmits a PUSCH to TRP #2 from panel #2 after transmitting a PUSCH to TRP #1 from panel #1 (switching the beam and panel). The two TRPs are connected to each other via an ideal backhaul.

### Multi-Panel Transmission

For Rel. 18 (or later versions), it is studied that for improvement of UL throughput/reliability, simultaneous UL transmission (for example, simultaneous multi-panel UL transmission (SiMPUL)) using a plurality of panels is supported for one or more TRPs. A multi-panel UL transmission scheme for a given UL channel (for example, PUSCH/PUCCH) and the like is also under study.

As multi-panel UL transmission, up to X panels (for example, X=2) and up to Y panels (for example, Y=2) may be supported, for example. When UL precoding indication for a PUSCH is supported in the multi-panel UL transmission, a codebook for existing systems (for example, Rel. 16 (or earlier versions)) may be supported for multi-panel simultaneous transmission. When single-DCI and multi-DCI based multi-TRP operations are considered, the number of layers and the number of codewords (CWs) may be up to x (for example, x=4) and up to y (for example, y=2) in all the panels, respectively.

For a multi-panel UL transmission scheme or candidates for the multi-panel UL transmission scheme, at least one of Schemes 1 to 3 below (multi-panel UL transmission schemes 1 to 3) is under study. Only one of Transmission Schemes 1 to 3 may be supported. A plurality of schemes including at least one of Transmission Schemes 1 to 3 may be supported, and one of the plurality of transmission schemes may be configured for the UE.

### Transmission Scheme 1: Coherent Multi-Panel UL Transmission

A plurality of panels may be synchronized with each other. All the layers are mapped to all the panels. A plurality of analog beams are indicated. An SRS resource indicator (SRI) field may be enhanced. This scheme may use up to four layers for UL.

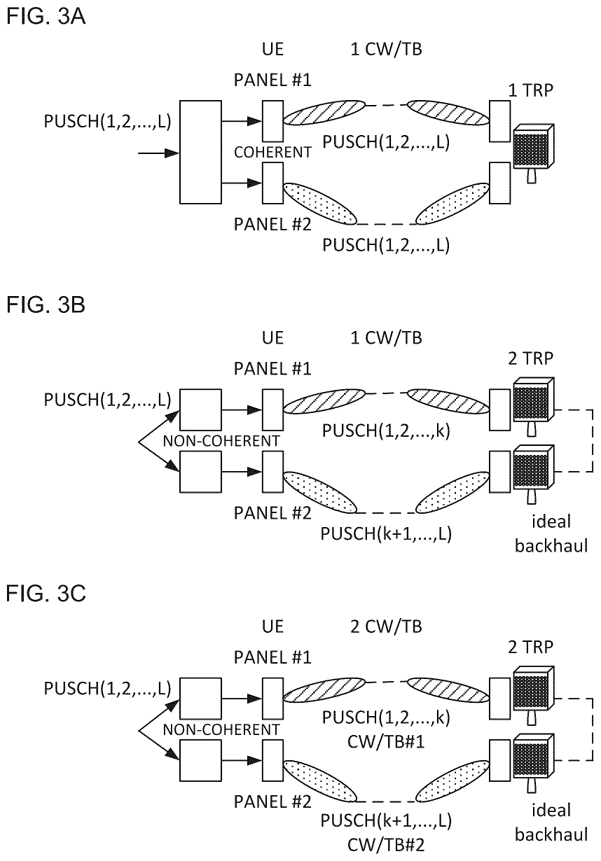

In an example in FIG. 3A, the UE maps one codeword (CW) or one transport block (TB) to L layers (PUSCH (1, 2, . . . , L)) to transmit L layers from each of the two panels. Panel #1 and panel #2 are coherent with each other. Transmission scheme 1 can obtain a gain by diversity. A total number of layers in the two panels is 2L. When a maximum value of the total number of layers is 4, a maximum value of the number of layers in one panel is 2.

### Transmission Scheme 2: Non-Coherent Multi-Panel UL Transmission With One Codeword (CW) or Transport Block (TB)

A plurality of panels may not be synchronized with each other. Different layers are mapped to different panels and one CW or TB for PUSCHs from the plurality of panels. Layers corresponding to one CW or TB may be mapped to the plurality of panels. This transmission scheme may use up to four layers or up to eight layers for UL. When up to eight layers are supported, this transmission scheme may support one CW or TB using up to eight layers.

In an example in FIG. 3B, the UE maps 1 CW or 1 TB to k layers (PUSCH (1, 2, . . . , k)) and L-k layers (PUSCH (k+1, k+2, . . . , L)) to transmit k layers and L-k layers from panel #1 and panel #2, respectively. Transmission scheme 2 can obtain a gain by multiplexing and diversity. A total number of layers in the two panels is L.

### Transmission Scheme 3: Non-Coherent Multi-Panel UL Transmission With Two CWs or TBs

A plurality of panels may not be synchronized with each other. Different layers are mapped to different panels and two CWs or TBs for PUSCHs from the plurality of panels. Layers corresponding to one CW or TB may be mapped to one panel. Layers corresponding to a plurality of CWs or TBs may be mapped to different panels. This transmission scheme may use up to four layers or up to eight layers for UL. When up to eight layers are supported, this transmission scheme may support up to four layers per CW or TB.

In an example in FIG. 3C, the UE maps CW #1 or TB #1 and CW #2 or TB #2 of the two CWs or 2 TBs to k layers (PUSCH (1, 2, . . . , k)) and L-k layers (PUSCH (k+1, k+2, . . . , L)), respectively, to transmit k layers and L-k layers from panel #1 and panel #2, respectively. Transmission scheme 3 can obtain a gain by multiplexing and diversity. A total number of layers in the two panels is L.

In each of the above transmission schemes, the base station may configure or indicate panel-specific transmission for UL transmission by using UL TCI or a panel ID. The UL TCI (UL TCI State) may be based on signaling similar to DL beam indication supported in Rel. 15. The panel ID may be implicitly or explicitly applied to transmission of at least one of a target RS resource or target RS resource set, a PUCCH, an SRS, and a PRACH. When the panel ID is explicitly notified, the panel ID may be configured in at least one of a target RS, a target channel, and a reference RS (for example, DL RS resource configuration or spatial relationship information).

For the above-described one or more communication schemes/modes, multi-panel UL transmission (for example, simultaneous multi-panel UL transmission (SiMPUL)) for scheduling of a PUSCH based on one DCI (single DCI)/scheduling of a PUSCH based on a plurality of DCIs (multi-DCIs) is under study.

### UE Capability Value Set

Rel-17 (or later versions) NR supports reporting of a list of UE capability value sets in a UE capability report. The UE capability value sets may mean panels supported/used by the UE. The UE capability value sets may be interpreted as UE capability values.

Each UE capability value set in Rel. 17 may be configured based on a maximum number of supported SRS ports. For example, when the maximum number of SRS ports is X, the UE reports X (for example, X=4) UE capability value sets.

The UE reports a list of UE capability value sets, thereby allowing UE-led panel activation and selection to be performed. Correspondence between a reported CSI-RS/SSB resource index (CRI/SSBRI) and one of the UE capability value sets in the reported list may be determined by the UE and notified to a NW in a beam report instance.

Rel-17 (or later versions) NR supports the UE that reports a list of UE capability value sets to promote UE-led panel activation and selection. Each UE capability value set included in the list consists of a maximum number of supported SRS ports, and any two UE capability value sets may be configured differently (or separately). The UE capability value sets may be configured in common for a plurality of (or all the) BWPs/CCs in the same band, or may be configured in common for a plurality of (or all the) BWPs/CCs in the same band combination (BC).

Each UE capability value set in Rel. 17 is constituted by a maximum number of supported SRS ports. In Rel. 18 (or later versions), the UE capability value set may be constituted by at least one of a maximum UL rank, a maximum number of beams, a maximum number of SRS resource sets, a maximum number of SRS resources, a maximum number of SRS resources per set, an EIRP, and a transmission power-related capability, in addition to (or in place of) the maximum number of supported SRS ports.

A case where a plurality of (for example, two) UE capability value sets are configured differently may mean that any two capability value sets include different maximum numbers of supported SRS ports. Note that the plurality of (for example, two) UE capability value sets may include the same capability. For example, the two UE capability value sets may include the same maximum number of supported SRS ports. In this case, the two UE capability value sets with the same maximum number of supported SRS ports may include other differently configured parameters (for example, EIRPs).

### PUSCH Transmission Using Multi-Panel

Any one of the following options may be applied to time/frequency resource indication for PUSCH transmission using multi-panel (or PUSCH repetition transmission).

### Space Division Multiplexing (SDM)

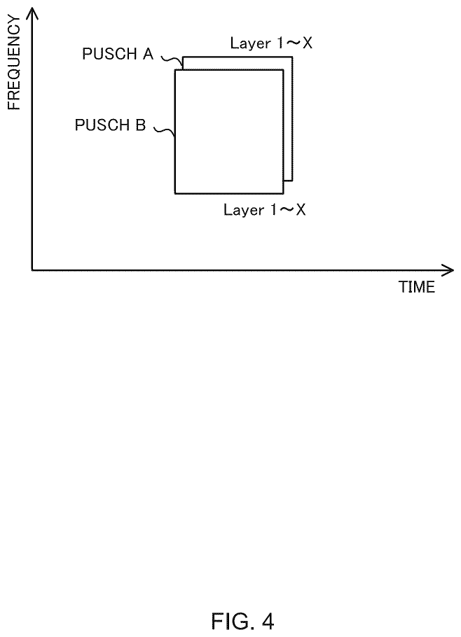

The UE may assume that PUSCH repetition transmission to which space division multiplexing (SDM) is applied is scheduled in the same time resource and the same frequency resource. In other words, when using a plurality of coherent panels, the UE may transmit, in the same time resource and the same frequency resource, the PUSCH repetition transmission to which the SDM is applied. FIG. 4 is a diagram to illustrate an example of the PUSCH repetition transmission to which the SDM is applied. In FIG. 4, time and frequency resources for PUSCH A and PUSCH B as repetition are the same.

### Frequency Division Multiplexing (FDM)

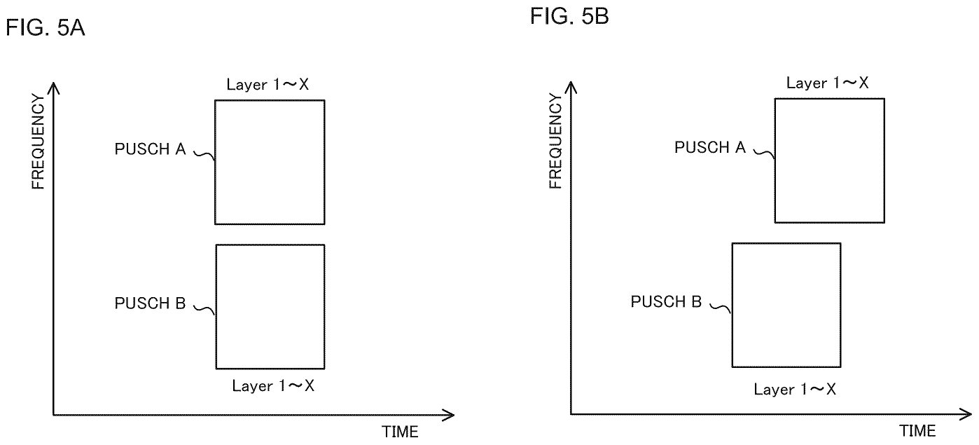

The UE may assume that PUSCH repetition transmission to which frequency division multiplexing (FDM) is applied is scheduled in the same time resource and different frequency resources. In other words, when using a plurality of coherent panels, the UE may transmit, in the same time resource and different frequency resources, the PUSCH repetition transmission to which the FDM is applied. FIG. 5A is a diagram to illustrate a first example of the PUSCH repetition transmission to which the FDM is applied. In FIG. 5A, time resources and frequency resources for PUSCH A and PUSCH B as repetitions are the same resources and different resources, respectively.

The UE may assume that the PUSCH repetition transmission to which the FDM is applied is scheduled in time resources partially overlapping each other (in one or a plurality of symbols) and different frequency resources. FIG. 5B is a diagram to illustrate a second example of the PUSCH repetition transmission to which the FDM is applied. In FIG. 5B, parts (one or a plurality of symbols) of the time resources and the frequency resources for PUSCH A and PUSCH B as repetitions are overlapping resources and different resources, respectively.

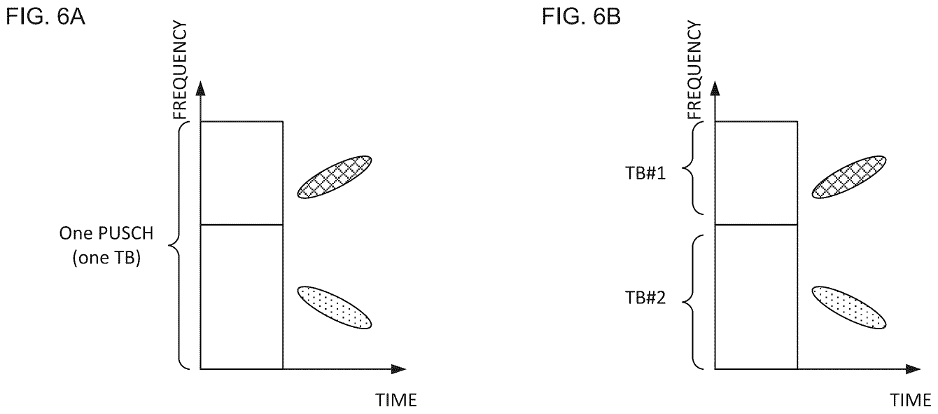

As another scheme for the FDM multi-panel PUSCH transmission, different frequency resources (for example, different RBs) for one PUSCH (or 1 TB) may be transmitted with different beams (for example, spatial relations/TCIs/SRIs)/panels (see FIG. 6A). FIG. 6A illustrates a case where one PUSCH (or 1 TB) is transmitted in different frequency resources by using different beams/panels.

As another scheme for the FDM multi-panel PUSCH transmission, two TBs may be scheduled by single DCI, and the two TBs may be transmitted in different frequency resources (for example, different RBs) by using different beams (for example, spatial relations/TCIs/SRIs)/panels (see FIG. 6B). FIG. 6B illustrates a case where TB #1 and TB #2 are transmitted in different frequency resources by using different beams/panels.

Thus, in Rel. 18 (or later versions) (for example, Rel-18 MIMO), it is assumed that when a plurality of UL transmissions (for example, a plurality of PUSCH transmissions/PUSCH repetition transmission) are performed by using multi-panel, frequency division multiplexing (FDM) is performed.

In such a case, a study has not been sufficiently made on how to control FDM for a PUSCH.

The inventors of the present invention studied transmission control in a case where one or more FDM schemes are used for a plurality of PUSCH transmissions using multi-panel, and came up with the idea of one aspect of the present embodiment.

### TB Size for PUSCH

The UE determines a transport block size (TB size) in PUSCH transmission. In the determination of the TB size, a total number of resource elements (REs) allocated to a PUSCH is determined. The total number of REs allocated to the PUSCH is determined based on a total number of PRBs allocated to the UE (or PUSCH).

Thus, the UE determines the TBS size, based on a total number of resource blocks (for example, PRBs) allocated to the PUSCH.

In this case, a case where a plurality of UL transmissions are performed by using FDM causes an issue related to how to determine/control the TB size when allocation of different numbers of PRBs are supported for respective frequency domain resources (for example, two beams/panels applied to FDMed frequency resources).

The inventors of the present invention studied determination/control of a TB size in a case where one or more FDM schemes are used for a plurality of PUSCH transmissions using multi-panel, and came up with the idea of one aspect of the present embodiment.

### Frequency Density of PT-RS

In Rel-15 NR, a base station may transmit a phase tracking reference signal (PTRS) on downlink. The base station may map and transmit the PTRS continuously or discontinuously in a time direction on a given number of (for example, one) subcarriers.

For example, the UE may receive the PTRS in at least part of a period (slot, symbol, or the like) in which a downlink shared channel (Physical Downlink Shared Channel (PDSCH)) is scheduled (in other words, a period for receiving the PDSCH). The PTRS transmitted by the base station may be referred to as a DL PTRS.

The UE may transmit a PTRS on uplink. The UE may map and transmit the PTRS continuously or discontinuously in a time direction on a given number of (for example, one) subcarriers.

For example, the UE may transmit the PTRS in at least part of a period (slot, symbol, or the like) in which an uplink shared channel (Physical Uplink Shared Channel (PUSCH)) is scheduled (in other words, a period for transmitting the PUSCH). The PTRS transmitted by the UE may be referred to as a UL PTRS.

The base station or the UE may determine, based on the received PTRS, a phase noise to compensate a phase error of a received signal (for example, a PUSCH or a PDSCH).

The UE may be configured with PTRS configuration information (PTRS-DownlinkConfig for DL, PTRS-UplinkConfig for UL) by higher layer signaling. For example, the PTRS configuration information may be included in configuration information of a demodulation reference signal (DMRS) for the PDSCH or the PUSCH (DMRS-DownlinkConfig or DMRS-UplinkConfig).

The PTRS configuration information may include information used to determine frequency density of the PTRS (for example, a “frequencyDensity” field of an RRC parameter). The information may be referred to as frequency density information. The frequency density information may indicate, for example, a threshold value related to the frequency density described below (for example, at least one of N_{RB0} and N_{RB1}).

The PTRS configuration information may be configured with different values for a DL PTRS and a UL PTRS. The PTRS configuration information may be configured for the UE for each Bandwidth Part (BWP) in a cell, or may be configured in common (cell-specific) for BWPs.

The UE may assume that when the PTRS configuration information is not configured (notified) (for example, before RRC connection), the PTRS is absent (is not included in a transmitted or received signal). When the PTRS configuration information is configured (notified) (for example, after RRC connection), the UE may determine a PTRS pattern (at least one of time density and frequency density), based on detected downlink control information (DCI).

For example, when at least one of time density information and frequency density information is configured, and a Radio Network Temporary Identifier (RNTI) used for Cyclic Redundancy Check (CRC) scrambling of the DCI is a specific RNTI (for example, a Cell-RNTI (C-RNTI) or a Configured Scheduling RNTI (CS-RNTI)), the UE may assume the presence of an antenna port for the PTRS, and may determine a PTRS pattern, based on a scheduled MCS (MCS) and a bandwidth scheduled by the DCI.

The UE may determine an MCS index (I_{MCS}), based on a Modulation and Coding Scheme (MCS) field of the DCI, and may determine time density L_{PT-RS} of the PTRS, based on I_{MCS} and a threshold value related to the above-described time density.

For example, the UE may determine L_{PT-RS} as follows:
Assume that the PTRS is absent if I_{MCS}<ptrs−MCS₁.
L_{PT-RS}=4 if ptrs−MCS₁≤I_{MCS}<ptrs−MCS₂.
L_{PT-RS}=2 if ptrs−MCS₂≤I_{MCS}<ptrs−MCS₃.
L_{PT-RS}=1 if ptrs−MCS₃≤I_{MCS}<ptrs−MCS₄.

The correspondence between the MCS index and the time density of the PTRS is not limited to this. For example, the number of threshold values may be less than or greater than four. Note that the L_{PT-RS} value may indicate that the smaller the L_{PT-RS} value is, the higher the density is, and may indicate, for example, an arrangement space between PTRS symbols.

The UE may determine the number (N_{RB}) of resource blocks to be scheduled based on a frequency domain resource allocation field of the DCI, and may determine frequency density K_{PT-RS} of the PTRS, based on N_{RB} and a threshold value related to the above-described frequency density.

For example, the UE may determine K_{PT-RS} as follows:
Assume that the PTRS is absent if N_{RB}<N_{RB0}.
K_{PT-RS}=2 if N_{RB0}≤N_{RB}<N_{RB1}.
K_{PT-RS}=4 if N_{RB1}≤N_{RB}.

The correspondence between the scheduled bandwidth and the frequency density of the PTRS is not limited to this. For example, the number of threshold values may be less than or greater than two. Note that the K_{PT-RS} value may indicate that the smaller the K_{PT-RS} value is, the higher the density is, and may indicate, for example, an arrangement space between PTRS subcarriers.

The UE may assume that when the time density information is not configured, L_{PT-RS} is a given value (for example, 1). The UE may assume that when the frequency density information is not configured, K_{PT-RS} is a given value (for example, 2). Note that the given values related to L_{PT-RS} and K_{PT-RS} may be predefined or may be configured by higher layer signaling.

Thus, the UE determines the frequency density of the PTRS, based on a total number of resource blocks (for example, PRBs) allocated to the PUSCH.

In this case, a case where a plurality of UL transmissions are performed by using FDM causes an issue related to how to determine/control frequency density of the PTRS when allocation of different numbers of PRBs are supported for respective frequency domain resources (for example, two beams/panels applied to FDMed frequency resources).

The inventors of the present invention studied determination/control of frequency density of a PTRS in a case where one or more FDM schemes are used for a plurality of PUSCH transmissions using multi-panel, and came up with the idea of one aspect of the present embodiment.

### Redundancy Version (RV) of PUSCH Repetition to Which TDM is Applied

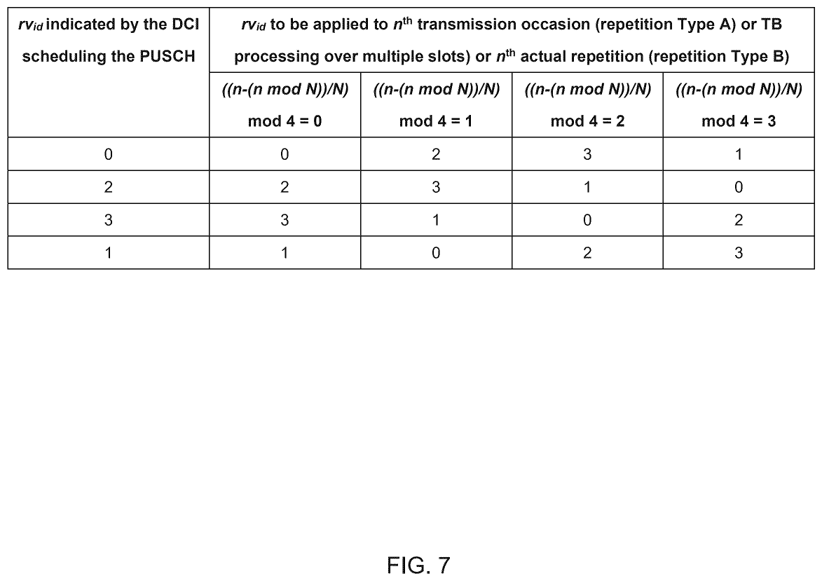

Rel. 17 supports application of a predefined redundancy version (RV) to PUSCH transmission (for example, PUSCH repetition) to which time division multiplexing (TDM) is applied (see FIG. 7).

FIG. 7 is a diagram to illustrate an example of mapping of the RV to each transmission occasion. The leftmost column of a table in FIG. 7 illustrates an RV index (rv_{id}) indicated by an RV field. The UE may determine, depending on this value, the RV index to be applied to the n th repetition (transmission occasion).

For example, the UE may determine that when rv_{id} indicated by the RV field is 0, ((n−(n mod N))/N) mod 4=0, 1, 2, and 3 correspond to rv_{id}=0, 2, 3, and 1, respectively.

In other words, the UE may use an RV indicated by the RV field as a start position in RV sequence {#0, #2, #3, #1} to apply, to each repetition, the first RV to the right in the RV sequence.

A case where a given FDM scheme is used for a plurality of PUSCH transmissions using multi-panel causes an issue related to how to determine/control an RV for each repetition.

The inventors of the present invention studied determination/control of an RV for each PUSCH repetition in a case where a given FDM scheme is used for a plurality of PUSCH transmissions using multi-panel, and came up with the idea of one aspect of the present embodiment.

### Number of Layers for PUSCH Repetition

In Rel. 16/Rel. 17, the number of transmission layers is limited to a single layer in PUSCH repetition transmission to which TDM is applied. The PUSCH repetition transmission corresponds to a repetition type A (for example, PUSCH TDM repetition type A) repeated in units of a slot.

A maximum transmission rank of the PUSCH is configurable by a higher layer parameter (for example, maxRank). Regarding the limitation to the number of layers for the PUSCH repetition type A of Rel. 16/17, even when the maximum rank of the PUSCH is configured to be greater than 1 (for example, 2 or 4) by the higher layer parameter, the UE does not expect scheduling of the PUSCH with rank>1 if the PUSCH repetition type A is scheduled (for example, if the number of repetitions is configured to be greater than 1). On the other hand, there is a case where the PUSCH with rank>1 is scheduled for the UE if the PUSCH repetition type A is not scheduled (for example, the number of repetitions is configured to equal 1).

A case where a given FDM scheme is used for a plurality of PUSCH transmissions using multi-panel causes an issue related to how to determine/control the number of layers (or limitation to the number of layers).

The inventors of the present invention studied determination/control of the number of layers (or the number of ranks) for PUSCH transmission in a case where a given FDM scheme is used for a plurality of PUSCH transmissions using multi-panel, and came up with the idea of one aspect of the present embodiment.

Embodiments according to the present disclosure will be described in detail with reference to the drawings as follows. The radio communication methods according to respective embodiments may each be employed individually, or may be employed in combination.

In the present disclosure, “A/B,” “at least one of A and B,” and “A and B” may be interchangeably interpreted. In the present disclosure, “A/B/C,” “at least one of A, B, and C,” and “A, B, and C” may be interchangeably interpreted.

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interpreted as a “set of spatial relation information,” “one or a plurality of spatial relation information,” and the like. The TCI state and the TCI may be interchangeably interpreted.

### Radio Communication Method

In each of the following embodiments, at least one of FDM Scheme #1 to FDM Scheme #3 below may be employed/supported as a PUSCH transmission scheme (for example, FDM multi-panel PUSCH transmission scheme). In FDM Scheme #1 to FDM Scheme #3, one or more PUSCHs may be scheduled by single DCI. Note that the PUSCH(s) may be interpreted as PUSCH transmission occasion(s), PUSCH repetition, or PUSCH resource(s).

### FDM Scheme #1

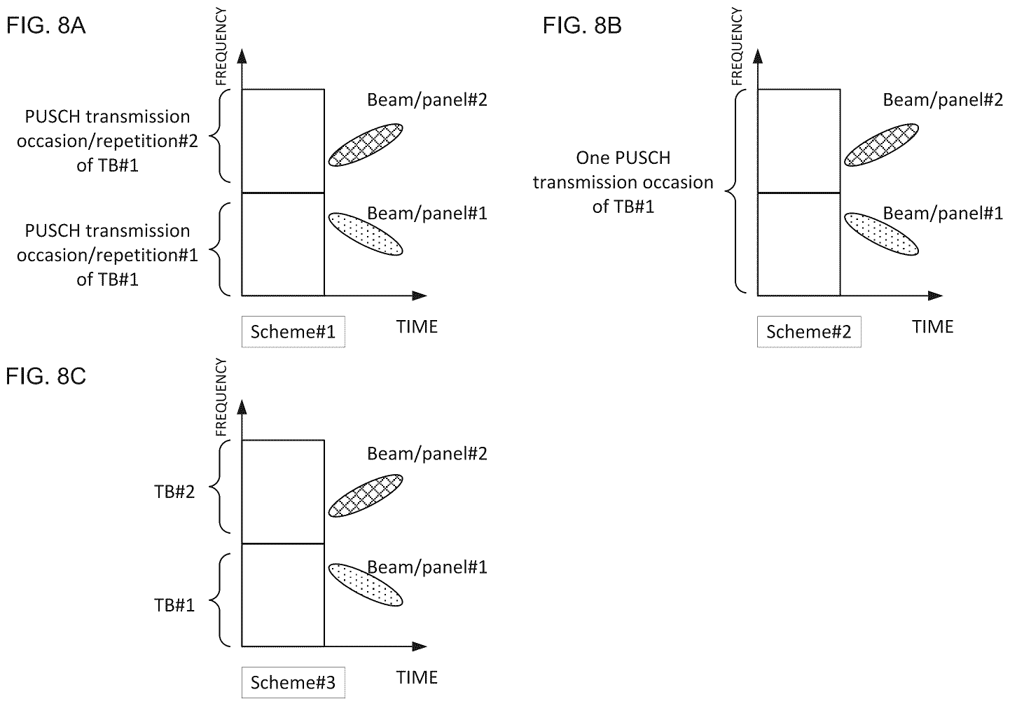

Two PUSCH transmission occasions (for example, repetitions) of the same TB (or 1 TB) are transmitted in identical time domain resources/time domain resources overlapping each other and frequency domain resources not overlapping each other. The two PUSCH transmission occasions (for example, the repetitions) of the same TB are transmitted by two respective beams/panels (for example, different beams/panels) (see FIG. 8A).

### FDM Scheme #2

One PUSCH transmission occasion (for example, repetition) of the same TB (or 1 TB) is transmitted by two beams/panels (for example, different beams/panels), and the respective beams/panels are associated with frequency domain resources not overlapping each other in PUSCH transmission (see FIG. 8B).

### FDM Scheme #3

Two TBs/CWs are transmitted in identical time domain resources/time domain resources overlapping each other and frequency domain resources not overlapping each other. The two TBs/CWs are transmitted by two respective beams/panels (for example, different beams/panels) (see FIG. 8C).

The beams may refer to spatial relations/SRIs/TCI states (or may be interpreted as spatial relations/SRIs/TCI states). The panels may refer to UE capability values, UE capability value sets, or UE antenna groups (or may be interpreted as UE capability value sets/UE antenna groups).

Alternatively, in the following description, a first beam/panel may be interpreted as a first SRI/TCI state, a first SRI field/first TCI state field, a first RSR resource set (for example, an SRS resource set with a lower ID), or a panel ID with a lower index. A second beam/panel may be interpreted as a second SRI/TCI state, a second SRI field/second TCI state field, a second RSR resource set (for example, an SRS resource set with a higher ID), or a panel ID with a higher index.

### First Embodiment

A first embodiment describes an example of allocation/configuration of frequency domain resources for a PUSCH transmitted by using an FDM scheme (for example, at least one of FDM Scheme #1 to FDM Scheme #3).

A UE may determine the frequency domain resources for the PUSCH, based on at least one of Option 1-1 to Option 1-3 below. In the present disclosure (for example, the respective embodiments), which of FDM Scheme #1, FDM Scheme #2, or FDM Scheme #3 is to be applied may be configured/indicated for the UE from a base station by using a higher layer parameter/MAC CE/DCI.

In FDM Scheme #1/FDM Scheme #2/FDM Scheme #3, the same option may be applied or application of separate options may be supported. Options to be applied to the respective FDM schemes may be defined in a specification, or may be configured/indicated for the UE from the base station by using a higher layer parameter/DCI. Alternatively, at least one of information related to a specific FDM scheme and information related to an option to be applied to the specific FDM scheme may be configured/indicated by RRC/DCI.

### Option 1-1

One set of frequency domain resources may be indicated for the UE. In the present disclosure, the frequency domain resources may be interpreted as given frequency units (for example, RBs, PRBs, VRBs, or subcarriers).

The indication of the frequency domain resources may be indicated by PUSCH frequency domain allocation for existing systems (for example, Rel. 17) (for example, Rel-17 PUSCH frequency domain allocation).

For example, one set of frequency domain resources (for example, a plurality of RBs) may be indicated for the UE by a frequency domain resource allocation (for example, FDRA) field of DCI used to schedule/activate the PUSCH.

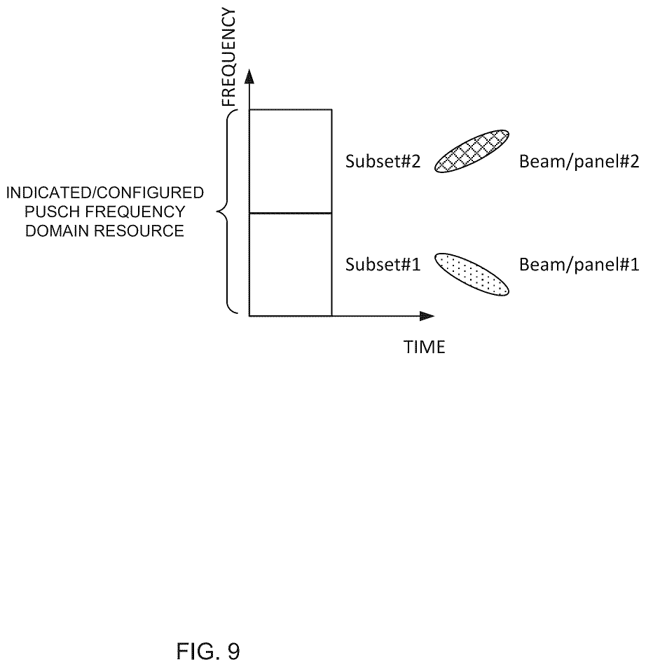

The one set of frequency domain resources (for example, one or more RBs) indicated for the UE may be divided into two subsets (see FIG. 9). FIG. 9 illustrates a case where the frequency domain resource allocation indicated for the UE is divided into subset #1 and subset #2.

A method for the division into subsets may be predefined in a specification, or may be notified to the UE by a higher layer parameter or the like.

For example, when N RBs are allocated, a first subset and a second subset may be the first N/2 RBs and the remaining RBs (for example, the second N/2 RBs), respectively. Note that N/2 may be replaced with a value obtained by applying a ceiling function to N/2 or a value obtained by applying a floor function to N/2. For example, one of the first subset and the second subset may be a value computed by applying a ceiling function or a floor function to N/2, and the other may be N−(computed value).

The first subset and the second subset of frequency domain resources may be associated with a first beam/panel and a second beam/panel, respectively. In the present disclosure, information related to the first beam/panel and information related to the second beam/panel may be configured/indicated for the UE from the base station by using a higher layer parameter/MAC CE/DCI. For example, this information may be indicated by using two SRI fields supported in Rel-17 PUSCH repetition, or may be indicated by using one or two TCI state fields supported in unified TCI.

In FDM Scheme #1, each subset of frequency domain resources may correspond to each PUSCH transmission occasion/repetition.

In FDM Scheme #2, all the frequency domain resources may correspond to one PUSCH transmission with 1 TB.

In FDM Scheme #3, each subset of frequency domain resources may correspond to each TB.

### Option 1-2

A first set of frequency domain resources (RBs) for the PUSCH may be indicated for the UE, and a second set of frequency domain resources may be determined based on a given rule.

The indication of the frequency domain resources may be indicated by PUSCH frequency domain allocation for existing systems (for example, Rel. 17) (for example, Rel-17 PUSCH frequency domain allocation).

For example, a first set of frequency domain resources (for example, one or more RBs) may be indicated for the UE by a frequency domain allocation field of DCI used to schedule/activate the PUSCH.

The second set of frequency domain resources may be determined based on a given relationship with the indicated first set of frequency domain resources. The given relationship may be at least one of the number of RBs and a start RB/end RB. The UE may determine the second set (or second frequency domain resources) in consideration of a given relationship with the indicated first set (or first frequency domain resources).

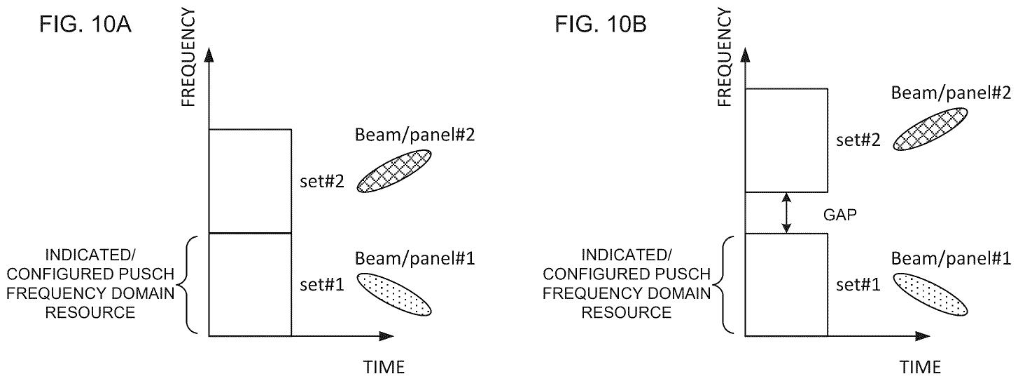

For example, the second set of frequency domain resources may be applied to/configured for/allocated to the same number of RBs as that of the first set (rule 1-2-1) (see FIG. 10A).

For example, the second set of frequency domain resources may be allocated/configured to be adjacent to the first set in the frequency domain (rule 1-2-2) (see FIG. 10A). When the first set is allocated to RB #X to RB #Y, the second set may be allocated to/configured for RB #Y+1 to RB #Z or RB #Z to RB #X−1.

Note that FIG. 10A illustrates a case where the number of RBs for the first set and the number of RBs for the second set are the same (combination of rules 1-2-1 and rules 1-2-2), but is not limited to this. The number of RBs for the first set and the number of RBs for the second set may be different from each other.

For example, a gap/offset may be provided between the first and second sets of frequency domain resources (rule 1-2-3) (see FIG. 10B). For example, a gap/offset of M RBs may be present between the first set and the second set. M may be defined in a specification or may be configured/indicated by a higher layer parameter/DCI. When the first set is allocated to RB #X to RB #Y, the second set may be allocated to/configured for RB #Y+M to RB #Z or RB #Z to RB #X−M.

Note that FIG. 10B illustrates a case where the number of RBs for the first set and the number of RBs for the second set are the same (combination of rules 1-2-1 and rules 1-2-3), but is not limited to this. The number of RBs for the first set and the number of RBs for the second set may be different from each other.

The UE may determine the second set, based on at least one of rule 1-2-1 to rule 1-2-3 (or combination of rule 1-2-1 and rule 1-2-2/combination of rule 1-2-1 and rule 1-2-3).

The first set and the second set of frequency domain resources may be associated with a first beam/panel and a second beam/panel, respectively. Information related to the first beam/panel and information related to the second beam/panel may be configured/indicated for the UE from the base station by using a higher layer parameter/MAC CE/DCI.

In FDM Scheme #1, each set of frequency domain resources may correspond to one PUSCH transmission occasion/repetition.

In FDM Scheme #2, all the frequency domain resources may correspond to one PUSCH transmission with 1 TB.

In FDM Scheme #3, each set of frequency domain resources may correspond to each TB (for example, one TB).

### Variations

A list of second frequency domain resource allocations (FDRAs) may be configured for the second set, and a first FDRA and a second FDRA may be indicated for the UE by one DCI field (for example, an FDRA field).

### Option 1-3

Two sets of frequency domain resources may be explicitly indicated for the UE.

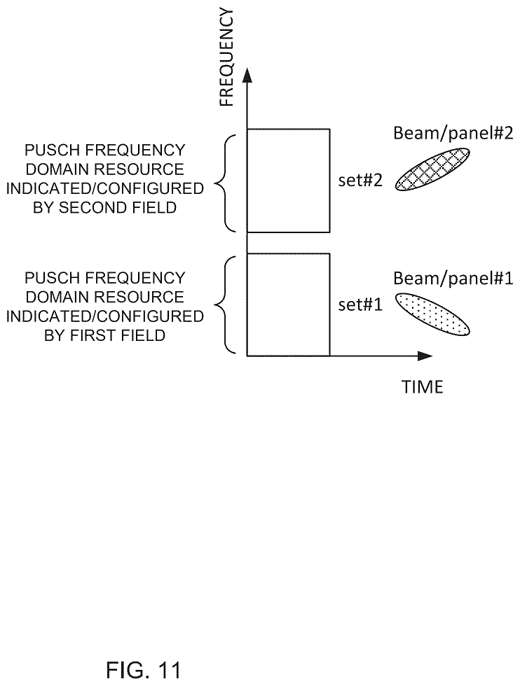

The two sets of frequency domain resources may be indicated by two respective fields (for example, a first field and a second field) included in DCI for scheduling the PUSCH (see FIG. 11). FIG. 11 illustrates a case where the first field indicates frequency domain allocation corresponding to the first set of frequency domain resources and where the second field indicates frequency domain allocation corresponding to the second set of frequency domain resources.

For example, the first set of frequency domain resources may be indicated by a frequency domain allocation (FDRA) field of DCI supported by Rel. 17, and the second set may be indicated by a new field. The new field may be referred to as an additional FDRA field or a second FDRA field.

Alternatively, the two sets of frequency domain resources may be indicated by two respective parts (for example, a first bit width and a second bit width) of a frequency domain resource allocation field included in DCI for scheduling the PUSCH.

Each field (or each part included in the field) may be, for example, the same as a frequency domain resource allocation field of DCI used for scheduling of a PUSCH in Rel. 17. Alternatively, each field may be the same as a frequency domain allocation field in a configured grant configuration of Rel. 17 (for example, a higher layer parameter “configuredgrantconfig”). Alternatively, each field may be the same as a frequency domain resource allocation field of DCI used to activate a configured grant based PUSCH in Rel. 17.

Alternatively, the first field and the second field may be fields included in a given higher layer parameter.

A list of second frequency domain resource allocations (FDRAs) may be configured for the second set, and a first FDRA and a second FDRA may be indicated for the UE by two fields (for example, FDRA fields) of DCI.

### Variation 1-3-1

When two FDRA fields are present (or configured) in the DCI, the granularity of the allocation of RBs to the PUSCH may be configured to be larger. For example, the granularity of the allocation of RBs may be increased to a unit of X RBs. X may be defined in a specification or may be configured/indicated for the UE from the base station by using a higher layer parameter/DCI.

When the granularity of the allocation of RBs to the PUSCH is changed (for example, increased) from that of existing systems (for example, Rel. 17 (or earlier versions)), granularity of allocation of RBs with a first FDRA field and granularity of allocation of RBs with a second FDRA field may be configured in common or separately (for example, differently).

### Variation 1-3-2

The first FDRA field may be configured to be the same as that of existing systems (for example, Rel. 17), and the second FDRA field may indicate only some parameters of parameters indicated by the first FDRA field.

For example, the second FDRA field may indicate only a start RB. In this case, the UE may assume that the number of RBs corresponding to the second FDRA is the same as the number of RBs indicated by the first FDRA field. The second FDRA field may indicate a start RB as offset for a start RB indicated by the first FDRA field.

In this case, sizes (bit widths) of the first FDRA field and the second FDRA field may be configured differently. For example, the size of the second FDRA field to be added may be smaller than the size of the first FDRA field. With this, an increase in DCI overhead can be suppressed.

The first set and the second set of frequency domain resources may be associated with a first beam/panel and a second beam/panel, respectively. Information related to the first beam/panel and information related to the second beam/panel may be configured/indicated for the UE from the base station by using a higher layer parameter/MAC CE/DCI.

In FDM Scheme #1, each set of frequency domain resources may correspond to one PUSCH transmission occasion/repetition.

In FDM Scheme #2, all the frequency domain resources may correspond to one PUSCH transmission with 1 TB.

In FDM Scheme #3, each set of frequency domain resources may correspond to each TB (for example, one TB).

### Second Embodiment

A second embodiment describes determination/control of a TB size for a PUSCH transmitted by using FDM schemes (for example, FDM Scheme #1 to FDM Scheme #3).

For the respective FDM schemes, a UE may perform determination of the TB size by using different mechanisms.

### FDM Scheme #1

In determination of the TB size in FDM Scheme #1, the UE may assume that the number of allocated RBs is the number of RBs corresponding to one of two beams/panels (or two subsets/sets of frequency domain resources). In other words, the UE may determine a TBS size, based on the assumption that the number of RBs corresponding to one of the two beams/panels (or the two subsets/sets of frequency domain resources) is the number of allocated RBs.

### Option 2-1

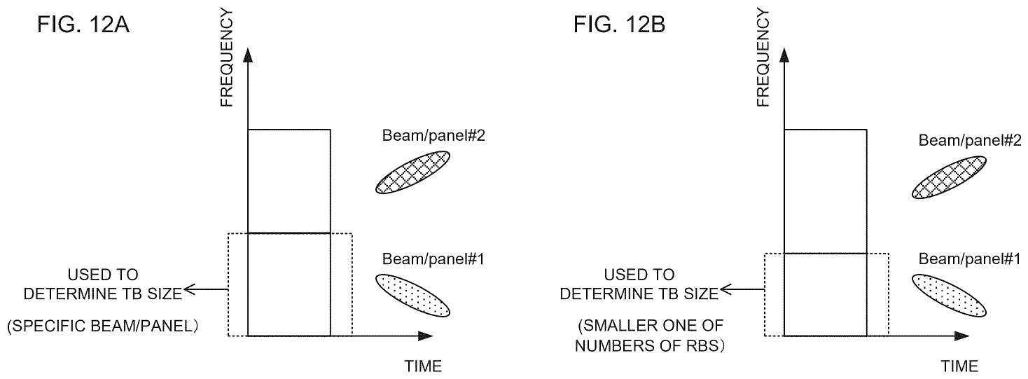

The UE may determine the TB size, based on the number of RBs corresponding to a specific beam/panel (or a specific subset/set of frequency domain resources) (see FIG. 12A). FIG. 12A illustrates a case where the TB size is determined based on the number of RBs corresponding to a first beam/panel (or a first subset/set of frequency domain resources).

Alternatively, the UE may determine the TB size, based on the number of RBs corresponding to a second beam/panel (or a second subset/set of frequency domain resources).

Alternatively, which of the number of RBs corresponding to the first beam/panel (or the first subset/set of frequency domain resources) or the number of RBs corresponding to the second beam/panel (or the second subset/set of frequency domain resources) is to be applied may be configurable. For example, which of the numbers of RBs is to be applied may be configured/indicated for the UE from a base station by using a higher layer parameter/DCI.

### Option 2-2

When the number of RBs corresponding to the first beam/panel (or the first subset/set of frequency domain resources) and the number of RBs corresponding to the second beam/panel (or the second subset/set of frequency domain resources) are different from each other, a smaller one of these numbers of RBs may be applied (see FIG. 12B). FIG. 12B illustrates a case where the TB size is determined based on the number of RBs corresponding to the first beam/panel (or the first subset/set of frequency domain resources) with a smaller number of RBs.

Alternatively, when the number of RBs corresponding to the first beam/panel (or the first subset/set of frequency domain resources) and the number of RBs corresponding to the second beam/panel (or the second subset/set of frequency domain resources) are different from each other, a larger one of these numbers of RBs may be applied.

Alternatively, when the number of RBs corresponding to the first beam/panel (or the first subset/set of frequency domain resources) and the number of RBs corresponding to the second beam/panel (or the second subset/set of frequency domain resources) are different from each other, the average of these numbers of RBs may be applied.

The TB sizes determined in accordance with Option 2-1/Option 2-2 may be applied to respective ones of a PUSCH associated with the first beam/panel (or the first subset/set of frequency domain resources) and a PUSCH associated with the second beam/panel (or the second subset/set of frequency domain resources).

### FDM Scheme #2

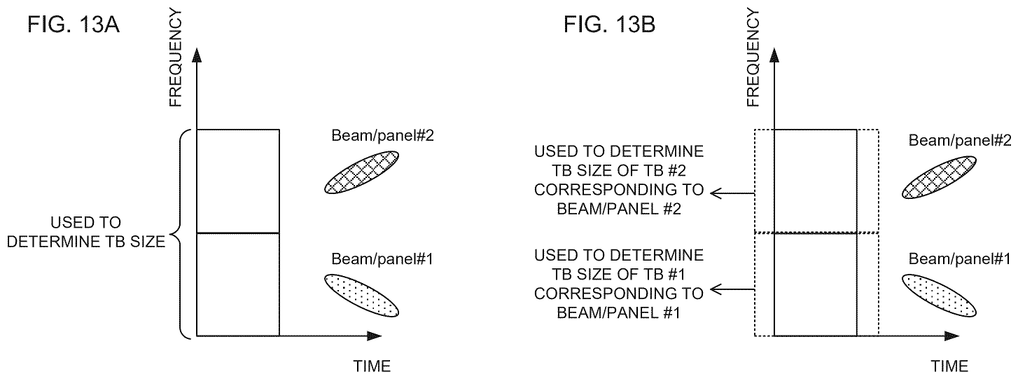

In determination of the TB size in FDM Scheme #2, the UE may assume that the number of allocated RBs is a total number of RBs corresponding to two beams/panels (or two subsets/sets of frequency domain resources) (see FIG. 13A). In other words, the UE may determine a TBS size, based on the assumption that the total number of RBs corresponding to the two beams/panels (or the two subsets/sets of frequency domain resources) is the number of allocated RBs.

In FIG. 13A, the UE may determine the TBS size, based on the number of RBs obtained by summing the number of RBs corresponding to first beam panel #1 (or a corresponding subset/set of frequency domain resources) and the number of RBs corresponding to second beam panel #2 (or a corresponding subset/set of frequency domain resources).

### FDM Scheme #3

In determination of the TB size in FDM Scheme #3, the UE determines a TB size of each TB, based on the assumption that the number of allocated RBs for each TB is the number of RBs associated with a beam/panel (or a subset/set of frequency domain resources) corresponding to each TB (see FIG. 13B).

In FIG. 13B, the UE may determine a TB size of TB #1, based on the number of RBs corresponding to first beam panel #1 (or a corresponding subset/set of frequency domain resources), and may determine a TB size of TB #2, based on the number of RBs corresponding to second beam panel #2 (or a corresponding subset/set of frequency domain resources).

Note that FIG. 13B illustrates a case where a TB size is determined for each FDM scheme by using a different method, but is not limited to this. TB sizes may be determined for at least two FDM schemes by using the same method.

### Third Embodiment

A third embodiment describes determination/control of frequency density of a PTRS of a PUSCH transmitted by using FDM schemes (for example, FDM Scheme #1 to FDM Scheme #3).

When applying at least one of FDM Scheme #1, FDM Scheme #2, and FDM Scheme #3, a UE may employ at least one of Option 3-1 to Option 3-3 below to control PTRS transmission. In FDM Scheme #1/FDM Scheme #2/FDM Scheme #3, the same option may be applied or application of separate options may be supported. Options to be applied to the respective FDM schemes may be defined in a specification, or may be configured/indicated for the UE from a base station by using a higher layer parameter/DCI. Alternatively, at least one of information related to a specific FDM scheme and information related to an option to be applied to the specific FDM scheme may be configured/indicated by RRC/DCI.

### Option 3-1

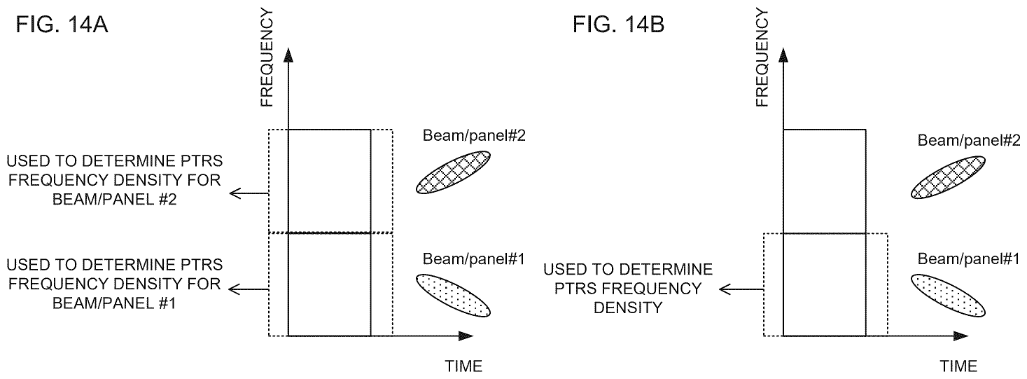

The UE may determine frequency density of the PTRS for each beam/panel (or a subset/set of frequency domain resources), based on the number of RBs corresponding to each beam/panel (or the subset/set of frequency domain resources) (see FIG. 14A).

For example, the UE may determine, based on the number of RBs corresponding to a first beam/panel (or a first subset/set of frequency domain resources), frequency density of the PTRS of the PUSCH corresponding to the first beam/panel. The UE may determine, based on the number of RBs corresponding to a second beam/panel (or a second subset/set of frequency domain resources), frequency density of the PTRS of the PUSCH corresponding to the second beam/panel.

### Option 3-2

The UE may determine frequency density of the PTRS, based on the number of RBs corresponding to one of two beams/panels (or subsets/sets of frequency domain resources) (see FIG. 14B). The determined frequency density of the PTRS may be applied to both of the beams/panels.

### Option 3-2-1

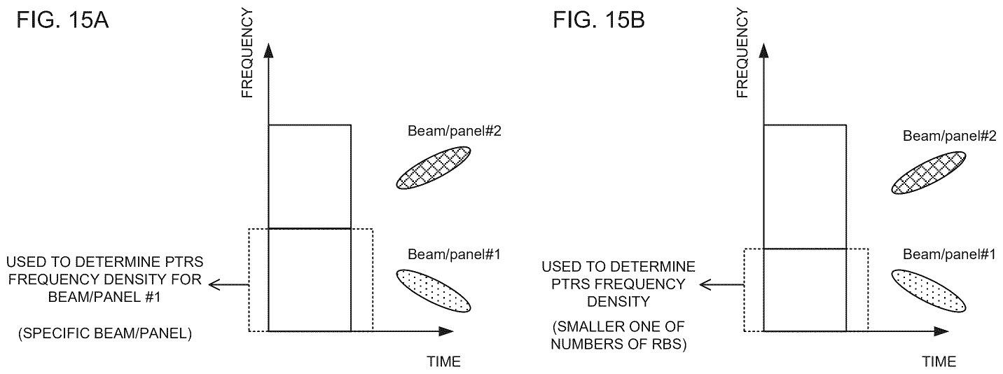

The UE may determine the frequency density of the PTRS, based on the number of RBs corresponding to a specific beam/panel (or a specific subset/set of frequency domain resources) (see FIG. 15A). FIG. 15A illustrates a case where the frequency density of the PTRS is determined based on the number of RBs corresponding to a first beam/panel (or a first subset/set of frequency domain resources).

Alternatively, the UE may determine the frequency density of the PTRS, based on the number of RBs corresponding to a second beam/panel (or a second subset/set of frequency domain resources).

Alternatively, which of the number of RBs corresponding to the first beam/panel (or the first subset/set of frequency domain resources) or the number of RBs corresponding to the second beam/panel (or the second subset/set of frequency domain resources) is to be applied may be configurable. For example, which of the numbers of RBs is to be applied may be configured/indicated for the UE from the base station by using a higher layer parameter/DCI.

### Option 3-2-2

When the number of RBs corresponding to the first beam/panel (or the first subset/set of frequency domain resources) and the number of RBs corresponding to the second beam/panel (or the second subset/set of frequency domain resources) are different from each other, a smaller one of these numbers of RBs may be applied (see FIG. 15B).

Alternatively, when the number of RBs corresponding to the first beam/panel (or the first subset/set of frequency domain resources) and the number of RBs corresponding to the second beam/panel (or the second subset/set of frequency domain resources) are different from each other, a larger one of these numbers of RBs may be applied.

Alternatively, when the number of RBs corresponding to the first beam/panel (or the first subset/set of frequency domain resources) and the number of RBs corresponding to the second beam/panel (or the second subset/set of frequency domain resources) are different from each other, the average of these numbers of RBs may be applied.

The TB sizes determined in accordance with Option 3-2-1/Option 3-2-2 may be applied to respective ones of a PUSCH associated with the first beam/panel (or the first subset/set of frequency domain resources) and a PUSCH associated with the second beam/panel (or the second subset/set of frequency domain resources).

### Option 3-3

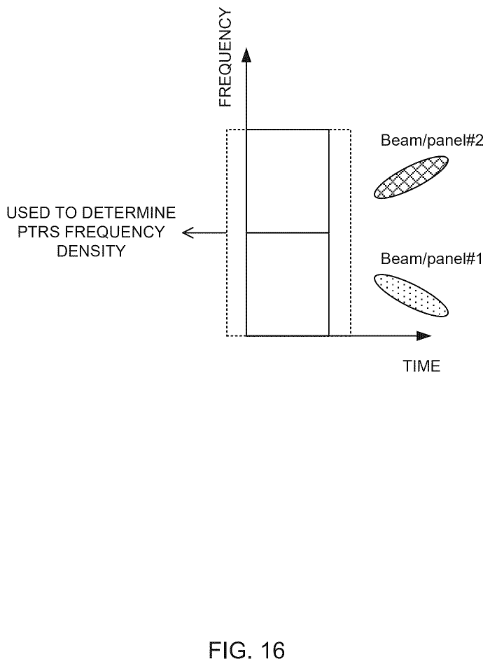

The UE may determine frequency density of the PTRS, based on a total number of RBs corresponding to two beams/panels (or subsets/sets of frequency domain resources) (see FIG. 16). The determined frequency density of the PTRS may be applied to both of the beams/panels.

In FIG. 16, the UE determines the frequency density of the PTRS, based on a total of the number of RBs corresponding to the first beam/panel (or the first subset/set of frequency domain resources) and the number of RBs corresponding to the second beam/panel (or the second subset/set of frequency domain resources). The UE may apply the determined frequency density of the PTRS to the PUSCH corresponding to the first beam/panel and the second beam/panel.

### Fourth Embodiment

A fourth embodiment describes a redundancy version (RV) applied to PUSCHs (for example, PUSCH repetition) each transmitted by using a given FDM scheme. Note that the following description describes, as an example of the given FDM scheme, FDM Scheme #1, but the applicable FDM scheme is not limited to this.

The UE may determine an RV to be applied to PUSCH transmission, based on at least one of Option 4-1 and Option 4-2 below.

### Option 4-1

The RV to be applied to the PUSCH transmission may be determined based on a given table. The given table may be an RV index (for example, rv_{id}) indicated by DCI for scheduling a PUSCH. The given table may be an association between an RV index (for example, rv_{id}) indicated by the DCI and an RV index applied to the n th transmission occasion.

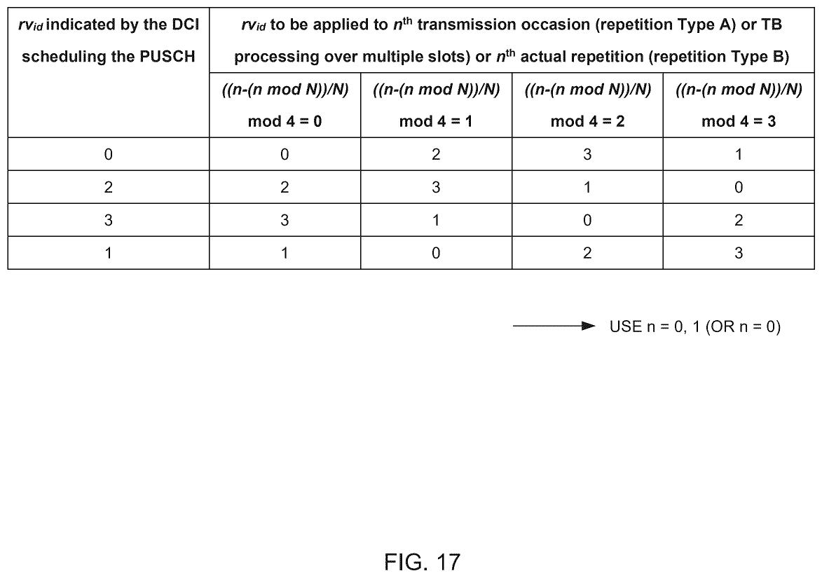

For example, the UE may apply, as the given table, an RV table for PUSCH transmission defined in Rel. 17 (or part of the table) (see FIG. 17). n may correspond to the order of transmission occasions for the PUSCH repetition (which repetition), and N may correspond to the number of slots used to determine a TBS (TB size).

The UE may apply n=0 and 1 to a PUSCH associated with a first beam/panel (or a first subset/set of frequency domain resources) and a PUSCH associated with a second beam/panel (or a second subset/set of frequency domain resources), respectively.

### Option 4-2

An RV for one of the PUSCH associated with the first beam/panel (or the first subset/set of frequency domain resources) and the PUSCH associated with the second beam/panel (or the second subset/set of frequency domain resources) may be determined based on a given table, and an RV for the other may be determined based on offset from the RV for one of these PUSCHs.

For example, the UE determines, in accordance with the given table (for example, FIG. 17), an RV for the PUSCH associated with the first beam/panel (or the first subset/set of frequency domain resources). In this case, the UE may determine the RV for the PUSCH associated with the first beam/panel (or the first subset/set of frequency domain resources), based on the assumption that n=0.

Subsequently, the UE may apply (or add) given offset to the RV for the PUSCH associated with the first beam/panel to determine an RV for the PUSCH associated with the second beam/panel (or the second subset/set of frequency domain resources). The given offset may be defined in a specification (for example, a fixed value) or may be configured/indicated for the UE from a base station by using a higher layer parameter/DCI.

For example, when the RV for the PUSCH associated with the first beam/panel is RV_1, RV_2 for the PUSCH associated with the second beam/panel may be determined by RV_2=(RV_1+given offset) mod 4.

### Fifth Embodiment

A fifth embodiment describes determination/control of the number of layers for a PUSCH transmitted by using FDM schemes (for example, FDM Scheme #1 to FDM Scheme #3).

In the following description, assume that a maximum transmission rank is configured by a higher layer parameter (for example, maxRank) and that the configured maximum transmission rank is Y. In this case, when at least one of FDM Scheme #1, FDM Scheme #2, and FDM Scheme #3 is applied/enabled/configured, the UE may employ at least one of Option 5-1 to Option 5-2 below.

### Option 5-1

Limitation to the maximum transmission rank of the PUSCH may not be added. In other words, the maximum transmission rank may remain Y. The UE may control, based on the maximum transmission rank Y, transmission of the PUSCH to which the FDM schemes are applied.

### Option 5-2

Limitation to the maximum transmission rank of the PUSCH may be added. For example, the maximum transmission rank of the PUSCH may be limited to a given value (for example, X). X may be smaller than Y. The UE may not expect that the PUSCH with the number of layers greater than X is scheduled.

For example, X may be predefined in a specification. As an example, X may equal a fixed value of 1 or 2.

X may be configured/indicated for the UE from the base station by using a higher layer parameter/DCI.

X may be defined/configured to vary depending on a value of the configured maximum transmission rank Y. For example, X=1 and X=2 may be applied to a case of Y=2 and a case of Y>2, respectively.

Note that, in FDM Scheme #1/FDM Scheme #2/FDM Scheme #3, the same option may be applied or application of separate options may be supported. Options to be applied to the respective FDM schemes may be defined in a specification, or may be configured/indicated for the UE from a base station by using a higher layer parameter/DCI. Alternatively, at least one of information related to a specific FDM scheme and information related to an option to be applied to the specific FDM scheme may be configured/indicated by RRC/DCI.

An FDM scheme to be configured/enabled/applied for the UE (for example, FDM Scheme #1/FDM Scheme #2/FDM Scheme #3) may be indicated by configuration of a higher layer parameter/DCI/associated parameter.

For example, a given FDM scheme may be configured/enabled for the UE by a higher layer parameter for indicating a transmission scheme (or FDM scheme).

Alternatively, a given FDM scheme may be indicated/enabled for the UE by DCI for indicating a transmission scheme (or FDM scheme).

Alternatively, a given FDM scheme may be indicated/enabled for the UE by DCI for indicating two beams (for example, SRIs/TCI states)/panels.

Alternatively, a given FDM scheme may be indicated/enabled for the UE by DCI for indicating two SRI fields/TCI state fields.

Alternatively, a given FDM scheme may be configured/enabled for the UE by configuration of two codebook (CB)/non-codebook (NCB) SRS resource sets.

### Variations

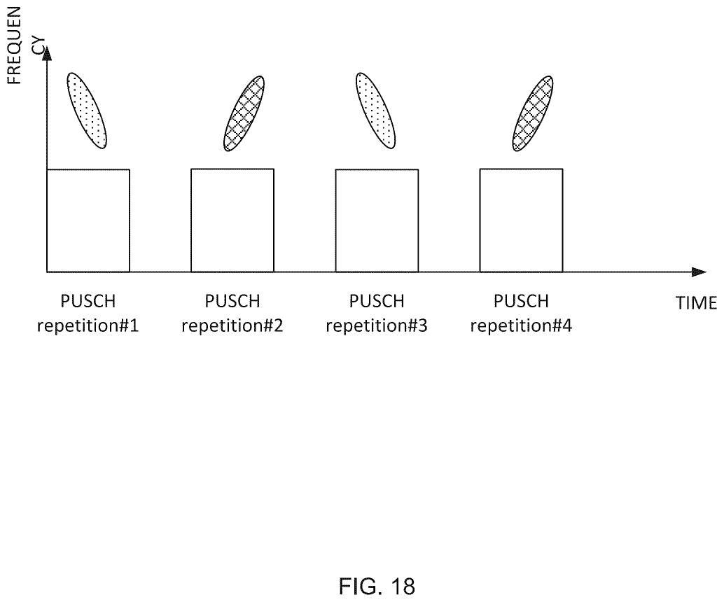

The above embodiments (for example, the first to third embodiments) may be employed in PUSCH repetition transmission using TDM (see FIG. 18). FIG. 18 illustrates a case where TDM is applied to PUSCH repetitions #1 to #4.

For example, different repetitions may be associated with different beams/panels. The mapping between the repetitions and the beams may be the same as that for multi-TRP PUSCH repetition supported in Rel. 17.

FIG. 18 illustrates a case where the same beam/panel (for example, a first beam/panel) is applied to odd-numbered PUSCH repetitions and where the same beam/panel (for example, a first beam/panel) is applied to even-numbered PUSCH repetitions, but is not limited to this.

The different beams/panels may be associated with the different sets/subsets of frequency domain resources described in the first embodiment. For example, the first beam/panel and the second beam/panel may correspond to a first set/subset and a second set/subset, respectively.

The mechanism for FDM Scheme #1 described in the second embodiment may be applied to TB size determination.

The mechanism described in the third embodiment may be applied to frequency density of a PTRS of each repetition.

### UE Capability Information

In the first to fifth embodiments above, the following UE capabilities may be configured. Note that the following UE capabilities may each be interpreted as a parameter (for example, a higher layer parameter) configured for the UE by a network (for example, the base station).

UE capability information related to whether to support FDM Scheme #1 may be defined.

UE capability information related to whether to support FDM Scheme #2 may be defined.

UE capability information related to whether to support FDM Scheme #3 may be defined.

The first to fifth embodiments may be employed in the UE that supports/reports at least one of the above-described UE capabilities. Alternatively, the first to fifth embodiments may be employed in the UE configured from the network.

### Supplementary Note

Regarding one embodiment of the present disclosure, the following supplementary notes of the invention will be given.

### Supplementary Note 1-1

A terminal including: a receiving section that receives one downlink control information used for scheduling of transmission of one or more uplink shared channels using a first frequency resource corresponding to a first beam or panel, and a second frequency resource corresponding to a second beam or panel and frequency-division multiplexed with the first frequency domain resource; and a control section that determines the first frequency resource and the second frequency resource, based on the downlink control information.

### Supplementary Note 1-2

The terminal according to supplementary note 1-1, wherein the control section divides, based on a given rule, one set of frequency domain resources indicated by the downlink control information to determine the first frequency resource and the second frequency resource.

### Supplementary Note 1-3

The terminal according to supplementary note 1-1 or 1-2, wherein the control section determines the second frequency resource, based on information related to the first frequency resource indicated by the downlink control information, and a given rule.

### Supplementary Note 1-4

The terminal according to any one of supplementary notes 1-1 to 1-3, wherein the control section determines the first frequency resource and the second frequency resource, based on a first field and a second field included in the downlink control information.

### Supplementary Note 2-1

A terminal including: a receiving section that receives one downlink control information used for scheduling of transmission of one or more uplink shared channels using a first frequency resource corresponding to a first beam or panel, and a second frequency resource corresponding to a second beam or panel and frequency-division multiplexed with the first frequency domain resource; and a control section that determines, based on at least one of information related to the first frequency resource and information related to the second frequency resource included in the downlink control information, at least one of a size of a transport block transmitted on the one or more respective uplink shared channels and frequency density of a phase tracking reference signal corresponding to the one or more uplink shared channels.

### Supplementary Note 2-2

The terminal according to supplementary note 2-1, wherein the control section determines at least one of the size of the transport block and the frequency density of the phase tracking reference signal, based on the number of resource blocks for a specific frequency resource from among the first frequency resource and the second frequency resource.

### Supplementary Note 2-3

The terminal according to supplementary note 2-1 or 2-1, wherein the control section determines at least one of the size of the transport block and the frequency density of the phase tracking reference signal, based on the number of resource blocks for a frequency resource with a smaller number of corresponding resource blocks, from among the first frequency resource and the second frequency resource.

### Supplementary Note 2-4

The terminal according to any one of supplementary notes 2-1 to 2-3, wherein the control section determines the frequency density of the phase tracking reference signal, based on a total of the number of resource blocks for the first frequency resource and the number of resource blocks for the second frequency resource.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

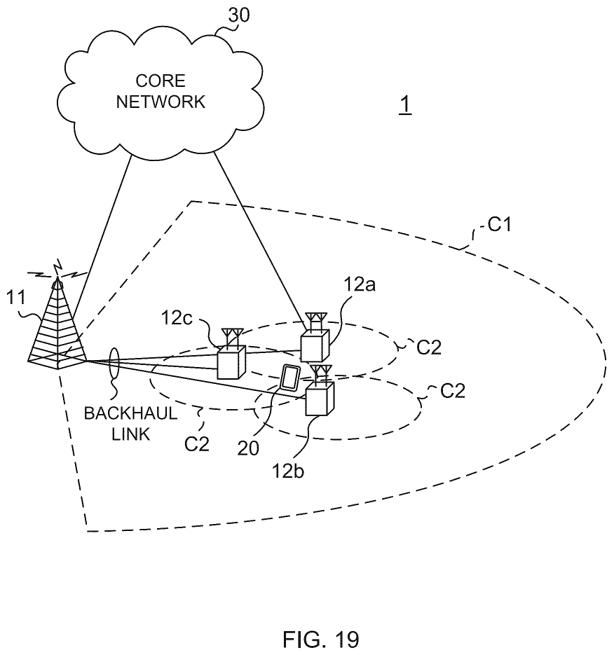

FIG. 19 is a diagram to illustrate an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect illustrated in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

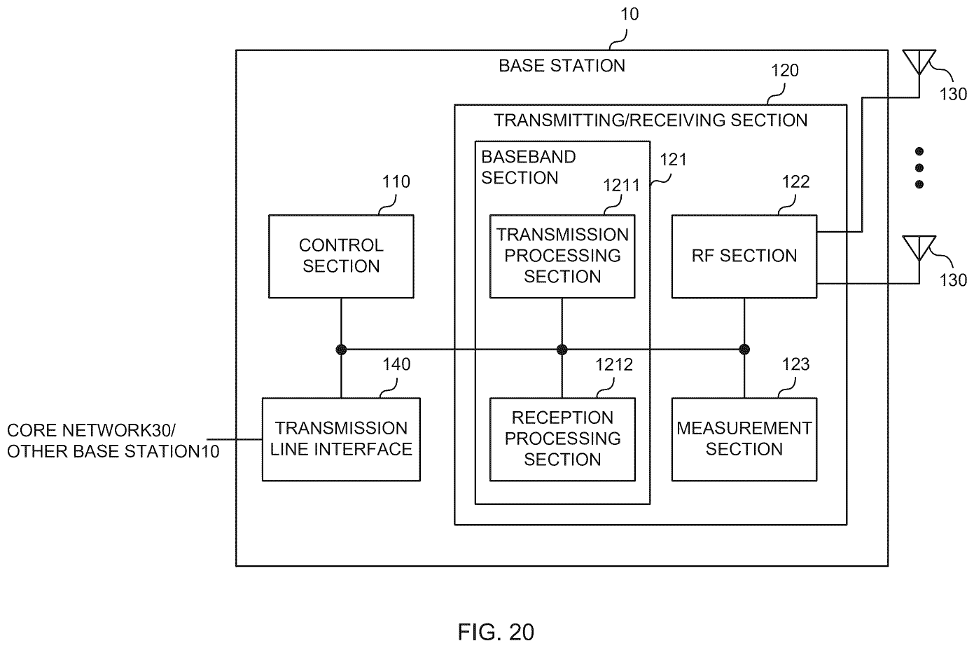

FIG. 20 is a diagram to illustrate an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily illustrates functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit one downlink control information used for scheduling of transmission of one or more uplink shared channels using a first frequency resource corresponding to a first beam or panel, and a second frequency resource corresponding to a second beam or panel and frequency-division multiplexed with the first frequency domain resource. The control section 110 may perform control so as to indicate, by using the downlink control information, allocation of the first frequency resource and the second frequency resource.

The transmitting/receiving section 120 may transmit one downlink control information used for scheduling of transmission of one or more uplink shared channels using a first frequency resource corresponding to a first beam or panel, and a second frequency resource corresponding to a second beam or panel and frequency-division multiplexed with the first frequency domain resource. The control section 110 may indicate, by using downlink control information, at least one of information related to the first frequency resource and information related to the second frequency resource to be used for determination of at least one of a size of a transport block transmitted on the one or more respective uplink shared channels and frequency density of a phase tracking reference signal corresponding to the one or more uplink shared channels.

### User Terminal

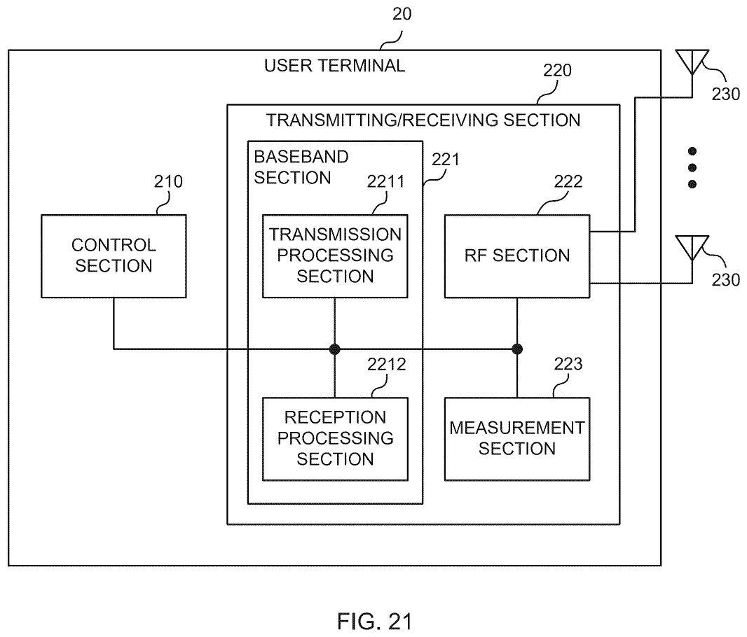

FIG. 21 is a diagram to illustrate an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily illustrates functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure received power (for example, RSRP), received quality (for example, RSRQ, SINR, SNR), signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive one downlink control information used for scheduling of transmission of one or more uplink shared channels using a first frequency resource corresponding to a first beam or panel, and a second frequency resource corresponding to a second beam or panel and frequency-division multiplexed with the first frequency domain resource. The control section 210 may determine the first frequency resource and the second frequency resource, based on the downlink control information.

The control section 210 may divide, based on a given rule, one set of frequency domain resources indicated by the downlink control information to determine the first frequency resource and the second frequency resource. The control section 210 may determine the second frequency resource, based on information related to the first frequency resource indicated by the downlink control information, and a given rule. The control section 210 may determine the first frequency resource and the second frequency resource, based on a first field and a second field included in the downlink control information.

The transmitting/receiving section 220 may receive one downlink control information used for scheduling of transmission of one or more uplink shared channels using a first frequency resource corresponding to a first beam or panel, and a second frequency resource corresponding to a second beam or panel and frequency-division multiplexed with the first frequency domain resource. The control section 210 may determine, based on at least one of information related to the first frequency resource and information related to the second frequency resource included in the downlink control information, at least one of a size of a transport block transmitted on the one or more respective uplink shared channels and frequency density of a phase tracking reference signal corresponding to the one or more uplink shared channels.

The control section 210 may determine at least one of the size of the transport block and the frequency density of the phase tracking reference signal, based on the number of resource blocks for a specific frequency resource from among the first frequency resource and the second frequency resource. The control section 210 may determine at least one of the size of the transport block and the frequency density of the phase tracking reference signal, based on the number of resource blocks for a frequency resource with a smaller number of corresponding resource blocks, from among the first frequency resource and the second frequency resource. The control section 210 may determine the frequency density of the phase tracking reference signal, based on a total of the number of resource blocks for the first frequency resource and the number of resource blocks for the second frequency resource.

### Hardware Structure

Note that the block diagrams that have been used to describe the above embodiments illustrate blocks in functional units. These functional blocks (components) may be implemented in arbitrary combinations of at least one of hardware and software. Also, the method for implementing each functional block is not particularly limited. That is, each functional block may be realized by one apparatus that is physically or logically coupled, or may be realized by directly or indirectly connecting two or more physically or logically separate of apparatuses (for example, via wire, wireless, or the like) and using these plurality of apparatuses. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

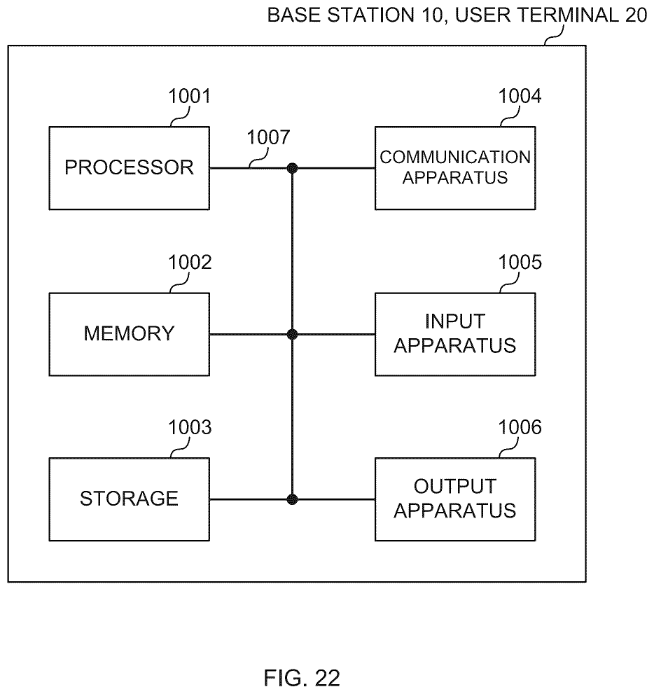

For example, a base station, a user terminal, and so on according to one embodiment of the present disclosure may function as a computer that executes the processes of the radio communication method of the present disclosure. FIG. 22 is a diagram to illustrate an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses illustrated in the drawings, or may be configured not to include part of apparatuses.

For example, although only one processor 1001 is illustrated, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these items of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE may not assume transmission/reception of a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a case that a base station transmits information to a terminal and a case that the base station indicates, for the terminal, control/operation based on the information may be interchangeably interpreted.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

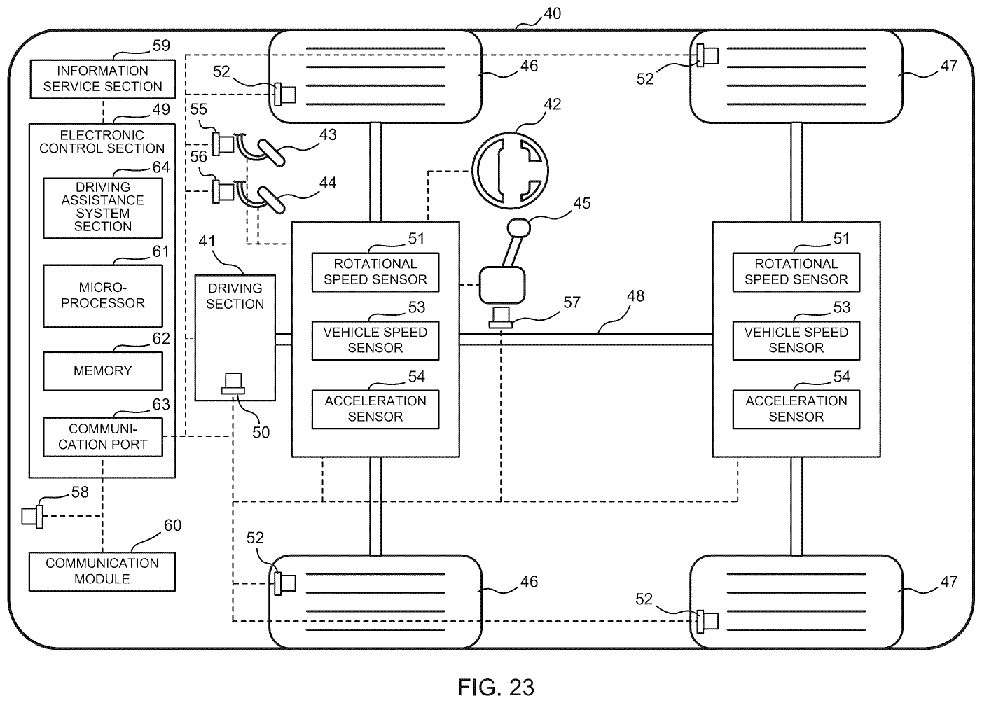

FIG. 23 is a diagram to illustrate an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various information such as drive information, traffic information, and entertainment information, such as a car navigation system, an audio system, a speaker, a display, a television, and a radio, and one or more ECUs that control these devices. The information service section 59 provides various information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various information (traffic information, signal information, inter-vehicle distance information, and the like) transmitted from the external apparatus, and displays the various information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various information received from the external apparatus in the memory 62 that can be used by the microprocessor 61. Based on the information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or smaller than,” “smaller than,” “equal to or larger than,” “larger than,” “equal to,” and the like may be interchangeably interpreted. In the present disclosure, words such as “good,” “poor,” “large,” “small,” “high,” “low,” “early,” “late,” “wide,” “narrow,” and the like may be interchangeably interpreted irrespective of positive degree, comparative degree, and superlative degree. In the present disclosure, expressions obtained by adding “i-th” (i is any integer) to words such as “good,” “poor,” “large,” “small,” “high,” “low,” “early,” “late,” “wide,” “narrow,” and the like may be interchangeably interpreted irrespective of positive degree, comparative degree, and superlative degree (for example, “highest” may be interpreted as “i-th highest,” and vice versa).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives one downlink control information used for scheduling transmission of one or more uplink shared channels using a first frequency resource and a second frequency resource:
the first frequency resource corresponding to a first beam or panel, and
the second frequency resource corresponding to a second beam or panel, and being frequency-division multiplexed with the first frequency domain resource; and
a control section that determines the first frequency resource and the second frequency resource based on the downlink control information.

2. The terminal according to claim 1, wherein
the control section divides, based on a given rule, one set of frequency domain resources indicated by the downlink control information to determine the first frequency resource and the second frequency resource.

3. The terminal according to claim 1, wherein
the control section determines the second frequency resource, based on information related to the first frequency resource indicated by the downlink control information, and a given rule.

4. The terminal according to claim 1, wherein
the control section determines the first frequency resource and the second frequency resource based on a first field and a second field included in the downlink control information.

5. A radio communication method for a terminal, the radio communication method comprising:
receiving one downlink control information used for scheduling transmission of one or more uplink shared channels using a first frequency resource and a second frequency resource:
the first frequency resource corresponding to a first beam or panel, and
the second frequency resource corresponding to a second beam or panel, and being frequency-division multiplexed with the first frequency domain resource; and
determining the first frequency resource and the second frequency resource based on the downlink control information.

6. A base station comprising:
a transmitting section that transmits one downlink control information used for scheduling transmission of one or more uplink shared channels using a first frequency resource and a second frequency resource:
the first frequency resource corresponding to a first beam or panel, and
the second frequency resource corresponding to a second beam or panel, and being frequency-division multiplexed with the first frequency domain resource; and
a control section that performs control so as to indicate, by using the downlink control information, allocation of the first frequency resource and the second frequency resource.
